(19) United States
(12) Patent Application Publication
(10) Pub. No.: US 2025/0343903 A1
(43) Pub. Date: Nov. 6, 2025

(54) TRANSMISSION DEVICE AND METHOD, MANAGEMENT DEVICE AND METHOD, RECEPTION DEVICE AND METHOD, PROGRAM, AND IMAGE TRANSMISSION SYSTEM

(71) Applicant: SONY GROUP CORPORATION, TOKYO (JP)

(72) Inventor: TAKAAKI FUCHIE, TOKYO (JP)

(21) Appl. No.: 18/865,167

(22) PCT Filed: May 2, 2023
(86) PCT No.: PCT/JP2023/017109

§ 371 Date: Nov. 12, 2024

(30) Foreign Application Priority Data
May 20, 2022 (JP) 2022-083032

(51) Int. Cl. H04N 19/11; H04N 19/107; H04N 19/172; H04N 19/184

(52) U.S. Cl. CPC H04N 19/11; H04N 19/107; H04N 19/172; H04N 19/184

(57) ABSTRACT

The present disclosure relates to a transmission device and method, a management device and method, a reception device and method, a program, and an image transmission system that make it possible to suppress image quality degradation due to the reproduction start. An image is encoded and a bitstream is generated, the bitstream is transmitted to a plurality of reception devices, a generation method for a reproduction start point is set according to one of the reception devices that starts reproduction, and the reproduction start point is generated by the generation method set. The present disclosure can be applied to, for example, a transmission device, a management device, a reception device, an electronic device, a transmission method, a management method, a reception method, a program, an image transmission system, and the like.

### TECHNICAL FIELD

The present disclosure relates to a transmission device and method, a management device and method, a reception device and method, a program, and an image transmission system, and more particularly, to a transmission device and method, a management device and method, a reception device and method, a program, and an image transmission system enabled to suppress image quality degradation due to the reproduction start.

### BACKGROUND ART

Conventionally, in a case where video is transmitted via a network, it has been required to suppress a transmission band. For that reason, the video is compressed and transmitted. As moving image encoding methods, for example, there have been Advanced Video Coding (AVC) (H.264), High Efficiency Video Coding (HEVC) (H.265), Versatile Video Coding (VVC) (H.266), and the like. In these encoding methods, intra prediction using intra-frame correlation or inter prediction using inter-frame correlation is applied.

Furthermore, an infinite Group Of Picture (GOP) structure has been considered as a low-delay stream structure with high encoding efficiency. In the case of the infinite GOP structure, only a picture (also referred to as a reproduction start point) whose decoding (reproduction) is started is an Intra Picture (I picture) to be encoded by using intra prediction, and all subsequent pictures are a Predictive Picture (P picture) or a Bidirectionally Predictive Picture (B picture) to be encoded by using inter prediction. Furthermore, the I picture has a data size suppressed in order to reduce the delay, and has low image quality. However, since the I picture is limited to the reproduction start point as described above, influence on subjective image quality is minimized.

Furthermore, for example, a method has been considered of performing prioritization according to a degree of importance of data and preferentially transmitting a packet with a higher priority (see, for example, Patent Document 1). Furthermore, for example, a method has been considered of assigning a priority to a packet according to a type of a picture (I picture, P picture, B picture) and selecting a packet to be transmitted according to the priority (see, for example, Patent Document 2).

### CITATION LIST

### Patent Document

Patent Document 1: Japanese Patent Application Laid-Open No. 2008-17221
Patent Document 2: Japanese Patent Application Laid-Open No. 2002-141945

### SUMMARY OF THE INVENTION

### Problems to be Solved by the Invention

Meanwhile, for example, in the case of an image transmission system for performing live video production, there has been a case where one bitstream is transmitted from one transmission device to a plurality of reception devices. In such a system, assuming that the stream structure is the infinite GOP structure, in a case where one of the reception devices starts reproduction, the transmission device inserts an I picture as a reproduction start point for the reception device.

However, for another reception device already performing reproduction, the I picture is inserted into a picture in the middle. That is, a picture with low image quality appears in the middle of reproduced video, and there has been a possibility that degradation in the subjective image quality of a reproduced image thereof increases. Furthermore, even if degrees of importance are set for data and pictures as in the methods described in Patent Document 1 and Patent Document 2, it has been difficult to suppress such degradation in the subjective image quality.

The present disclosure has been made in view of such a situation, and an object thereof is to make it possible to suppress image quality degradation due to the reproduction start.

### Solutions to Problems

A transmission device of one aspect of the present technology is a transmission device including: an encoding unit that encodes an image and generates a bitstream; a transmission unit that transmits the bitstream to a plurality of reception devices; and an encoding control unit that sets a generation method for a reproduction start point according to one of the reception devices that starts reproduction, and controls the encoding unit to generate the reproduction start point by the generation method set.

A transmission method of one aspect of the present technology is a transmission method including: encoding an image and generating a bitstream; transmitting the bitstream to a plurality of reception devices; and setting a generation method for a reproduction start point according to one of the reception devices that starts reproduction, and generating the reproduction start point by the generation method set.

A program of one aspect of the present technology is a program for causing a computer to function as: an encoding unit that encodes an image and generates a bitstream; a transmission unit that transmits the bitstream to a plurality of reception devices; and an encoding control unit that sets a generation method for a reproduction start point according to one of the reception devices that starts reproduction, and controls the encoding unit to generate the reproduction start point by the generation method set.

A management device of another aspect of the present technology is a management device including a setting unit that sets a specific reception device among a plurality of reception devices capable of receiving bitstreams identical to each other transmitted from a transmission device.

A management method of another aspect of the present technology is a management method including setting a specific reception device among a plurality of reception devices capable of receiving bitstreams identical to each other transmitted from a transmission device.

A program of another aspect of the present technology is a program for causing a computer to function as a setting unit that sets a specific reception device among a plurality of reception devices capable of receiving bitstreams identical to each other transmitted from a transmission device.

A reception device of still another aspect of the present technology is a reception device including: a reception unit that holds information indicating whether or not the reception device is a specific reception device, provides a transmission device with the information and requests the transmission device to generate a reproduction start point when reproduction is started, and receives a bitstream transmitted from the transmission device; and a decoding unit that decodes the bitstream and generates an image.

A reception method of still another aspect of the present technology is a reception method including: holding information indicating whether or not the reception device is a specific reception device, providing a transmission device with the information and requesting the transmission device to generate a reproduction start point when reproduction is started, and receiving a bitstream transmitted from the transmission device; and decoding the bitstream and generating an image.

An image transmission system of still another aspect of the present technology is an image transmission system including: a transmission device that transmits bitstreams including coded data of an image; and a plurality of reception devices capable of receiving the bitstreams identical to each other transmitted from the transmission device, in which the transmission device includes: an encoding unit that encodes the image and generates the bitstreams; a transmission unit that transmits the bitstreams to the plurality of reception devices; and an encoding control unit that sets a generation method for a reproduction start point according to one of the reception devices that starts reproduction, and controls the encoding unit to generate the reproduction start point by the generation method set, and the reception devices each include: a reception unit that requests the transmission device to generate the reproduction start point when reproduction is started, and receives a bitstream transmitted from the transmission device; and a decoding unit that decodes the bitstream and generates an image.

In the transmission device, method, and program of one aspect of the present technology, an image is encoded and a bitstream is generated, the bitstream is transmitted to a plurality of reception devices, a generation method for a reproduction start point is set according to one of the reception devices that starts reproduction, and the reproduction start point is generated by the generation method set.

In the management device, method, and program of another aspect of the present technology, a specific reception device is set among a plurality of reception devices capable of receiving bitstreams identical to each other transmitted from a transmission device.

In the reception device and method of still another aspect of the present technology, information indicating whether or not the reception device is a specific reception device is held, a transmission device is provided with the information and is requested to generate a reproduction start point when reproduction is started, a bitstream transmitted from the transmission device is received, and the bitstream is decoded and an image is generated.

In the image transmission system of still another aspect of the present technology, included are: a transmission device that transmits bitstreams including coded data of an image; and a plurality of reception devices capable of receiving the bitstreams identical to each other transmitted from the transmission device, in which: in the transmission device, an image is encoded and the bitstreams are generated, the bitstreams are transmitted to the plurality of reception devices, a generation method for a reproduction start point is set according to one of the reception devices that starts reproduction, and a reproduction start point is generated by the generation method set; and in the reception devices, the transmission device is requested to generate a reproduction start point when reproduction is started, a bitstream transmitted from the transmission device is received, and the bitstream is decoded and an image is generated.

### BRIEF DESCRIPTION OF DRAWINGS

FIG. 1 is a diagram illustrating an example of a GOP.

FIG. 2 is a diagram illustrating an example of intra refresh.

FIG. 3 is a diagram illustrating an example of an infinite GOP.

FIG. 4 is a diagram illustrating an example of reproduction start in the case of an infinite GOP.

FIG. 5 is a diagram illustrating a main configuration example of an image transmission system.

FIG. 6 is a block diagram illustrating a main configuration example of a management device.

FIG. 7 is a block diagram illustrating a main configuration example of a transmission device.

FIG. 8 is a block diagram illustrating a main configuration example of an encoding unit.

FIG. 9 is a block diagram illustrating a main configuration example of a reception device.

FIG. 10 is a block diagram illustrating a main configuration example of a decoding unit.

FIG. 11 is a flowchart illustrating an example of a flow of setting processing.

FIG. 12 is a flowchart illustrating an example of a flow of image transmission processing.

FIG. 13 is a flowchart subsequent to FIG. 12, illustrating an example of the flow of the image transmission processing.

FIG. 14 is a flowchart illustrating an example of a flow of encoding processing.

FIG. 15 is a flowchart illustrating an example of a flow of decoding processing.

FIG. 16 is a diagram illustrating a comparative example of frame timing in a case where a most important reception device starts reproduction.

FIG. 17 is a diagram illustrating an example of a state of change in a bit rate in a case where the most important reception device starts reproduction.

FIG. 18 is a diagram illustrating a comparative example of frame timing in a case where a non-most important reception device starts reproduction.

FIG. 19 is a diagram illustrating an example of a state of change in a bit rate in a case where the non-most important reception device starts reproduction.

FIG. 20 is a diagram illustrating a main configuration example of an image transmission system.

FIG. 21 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Documents and the like supporting technical content and technical terms
2. Image transmission
3. First embodiment (image transmission system)
4. Application examples
5. Supplementary note

### 1. Documents and the Like Supporting Technical Content and Technical Terms

The scope disclosed in the present technology includes not only the contents described in the embodiments but also the contents described in the following Non-Patent Documents and Patent Documents and the like which are publicly known at the time of filing, the contents of other documents referred to in the following Non-Patent Documents and Patent Documents, and the like.
Patent Document 1: (described above)
Patent Document 2: (described above)
Non-Patent Document 1: Recommendation ITU-T H.264 (April 2017) “Advanced video coding for generic audiovisual services”, April 2017
Non-Patent Document 2: Recommendation ITU-T H.265 (February 2018) “High efficiency video coding”, February 2018
Non-Patent Document 3: Benjamin Bross, Jianle Chen, Shan Liu, Ye-Kui Wang, “Versatile Video Coding (Draft 10)”, JVET-S2001-vH, Joint Video Experts Team (JVET) of ITU-T SG 16 WP 3 and ISO/IEC JTC 1/SC 29/WG 11 19th Meeting: by teleconference, 22 Jun.-1 Jul. 2020

That is, the contents described in the above Patent Documents and Non-Patent Documents also serve as a basis for determining the support requirement. For example, even in a case where the quad-tree block structure and the quad tree plus binary tree (QTBT) block structure described in the above-described Non-Patent Documents are not directly described in the embodiments, they are within the scope of disclosure of the present technology and are assumed to satisfy the support requirement of the claims. Furthermore, for example, technical terms such as parsing, syntax, and semantics are similarly within the scope of the disclosure of the present technology even in a case where there is no direct description in the embodiment, and meet the support requirement of the claims.

Furthermore, in the present specification, a “block” (not a block indicating a processing unit) used in the description as a partial region or a unit of processing of an image (picture) indicates any partial region in the picture unless otherwise especially mentioned, and its size, shape, characteristics and the like are not limited. For example, examples of the “block” include any partial region (unit of processing) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a sub-block, a macroblock, a tile, or a slice described in the above-described Non-Patent Documents.

### 2. Image Transmission

### <Stream Structure>

Conventionally, for example, in a case where live video production is performed, a video captured by a camera has been transmitted to a broadcast video production device such as a switcher by using a dedicated wiring, and video production has been performed such as switching a video to be transmitted or adding a caption. In recent years, with the progress of communication technologies represented by the next-generation communication standard “5G”, large-capacity and low-delay communication is being achieved. By increasing the capacity and reducing the delay of wireless communication, it is possible to transmit a video, which has been transmitted by using a conventional dedicated wiring, by wireless video streaming with low delay, and it is possible to perform highly mobile and low cost production.

Furthermore, by achieving large-capacity and low-delay communication regardless of wired communication or wireless communication, it is becoming possible to perform low cost production, such as transmitting a video captured by a camera at a remote location to a production studio having production equipment or a data center providing a cloud service via a network and remotely performing live video production.

As described above, in a case where video is transmitted via a network, there is generally an upper limit on the available band, and it is required to transmit video in a predetermined band. Furthermore, securing a large band leads to an increase in cost of facilities and lines, and thus it is required to suppress a transmission band.

In order to reduce the transmission band, a video has been generally compressed and transmitted. As moving image encoding methods, for example, there have been Advanced Video Coding (AVC) (H.264), High Efficiency Video Coding (HEVC) (H.265), Versatile Video Coding (VVC) (H.266), and the like. In these encoding methods, intra prediction using intra-frame correlation or inter prediction using inter-frame correlation is applied.

### <Comparison of Stream Structure>

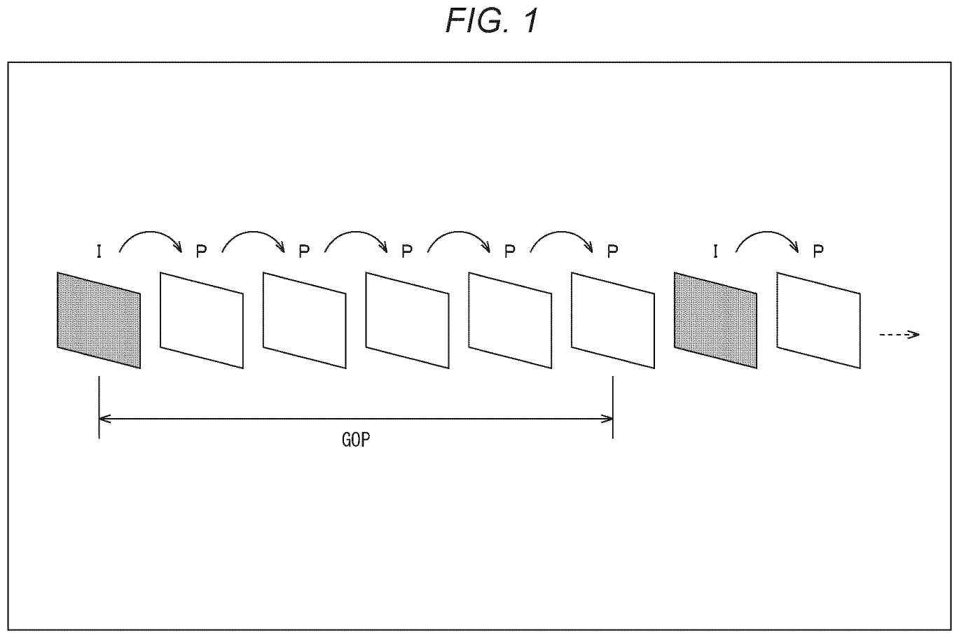

Furthermore, in such video transmission, low latency has also been generally required. As a stream structure of a bitstream of a moving image, for example, there has been a long group of picture (GOP) structure. In the case of the long GOP structure, as illustrated in FIG. 1, each picture is encoded so as to form a GOP including an I picture to be encoded by using intra prediction and a P picture (and a B picture) to be encoded by using inter prediction. In this case, a code amount of the I picture is large, and a code amount of the P picture (and the B picture) is small. In order to absorb such a difference in the code amount of each picture and keep a transmission rate constant, the bitstream is transmitted via a smoothing buffer. For that reason, there has been a possibility that a delay increases. In general, the larger the capacity of the smoothing buffer, the larger the allowable difference in the code amount between pictures, but the delay increases.

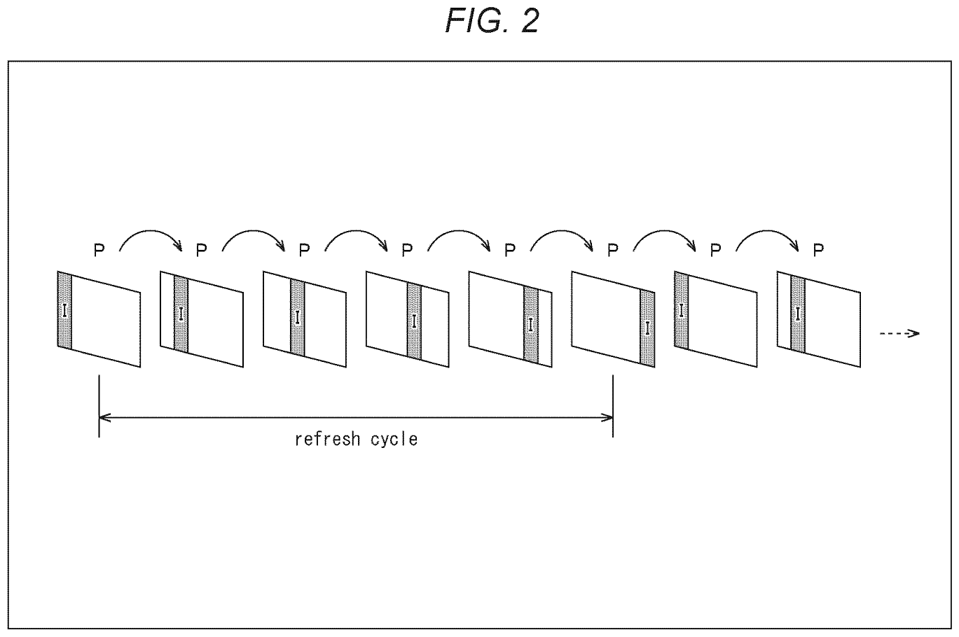

Thus, as illustrated in FIG. 2, intra refresh has been considered in which an I slice is inserted into a P picture (or a B picture), the I slice being a slice to be encoded by using intra prediction. In the case of the intra refresh, an encoder divides the I picture into a plurality of I slices, and inserts the I slices into respective different P pictures (or B pictures). Thus, a decoder can combine the I slices inserted into the respective pictures during a refresh cycle to obtain the I picture. That is, in the case of the intra refresh, there is no I picture, and the code amounts of respective pictures are made uniform as compared with the case of the long GOP structure. Thus, the capacity of the smoothing buffer can be reduced as compared with the case of the long GOP structure. However, the decoder cannot start reproduction until the refresh cycle elapses after reception is started.

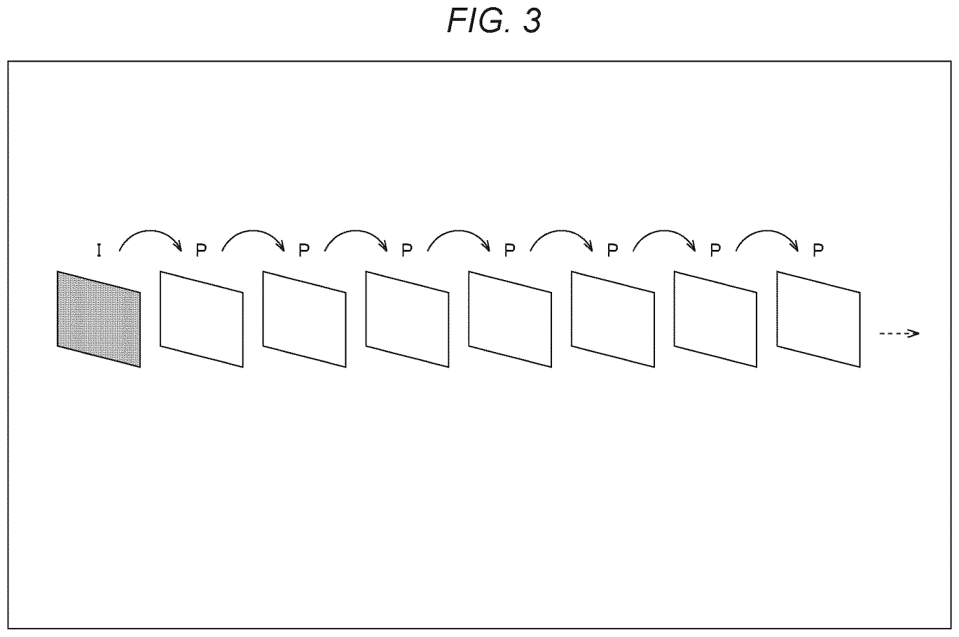

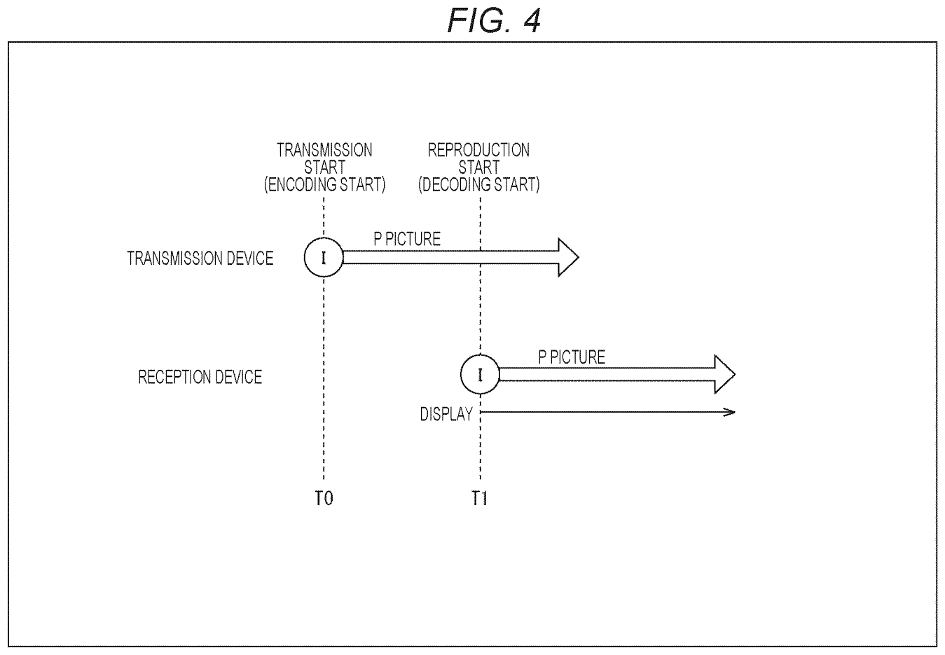

Thus, an infinite GOP structure has been considered as a low-delay stream structure with good encoding efficiency. In the case of the infinite GOP structure, as illustrated in FIG. 3, only a picture (also referred to as a reproduction start point) in which decoding (reproduction) is started is set as an I picture to be encoded by using intra prediction, and all subsequent pictures are set as P pictures or B pictures to be encoded by using inter prediction. Thus, as illustrated in FIG. 4, similarly to the case of the long GOP structure, a reception device can start reproduction from time T1 at which the I picture at the reproduction start point is received.

Furthermore, in the case of the infinite GOP structure, in order to reduce the delay, data sizes are controlled to be substantially constant in units of data of a picture or less. That is, the data size of the I picture is suppressed to be substantially equal to that of the P picture (or the B picture). Thus, a reproduced image of the I picture has low image quality. However, since the I picture is limited to the reproduction start point as described above, low image quality is achieved in the reproduced video only in a short period immediately after reproduction start with a relatively low degree of importance. In other words, a picture in the middle of the reproduced video does not have low image quality. Thus, influence of the reproduced video on subjective image quality is minimized.

Since the infinite GOP structure is a stream structure as described above, the decoder can start reproduction only from the I picture at the reproduction start point as illustrated in FIG. 4. In other words, in the case of the infinite GOP, it has been necessary for the encoder to insert an I picture (generate a reproduction start point) in order for the decoder to start reproduction.

### <Influence of Reproduction Start on Subjective Image Quality of Reproduced Image>

For example, in the case of an image transmission system for performing live video production as described above, there has been a case where one bitstream is transmitted from one transmission device to a plurality of reception devices. For example, a use case is considered in which a video captured by one camera is transmitted to a system used for live broadcasting and is also transmitted to a system used for confirmation (monitoring) or a system used for recording. Assuming that the stream structure is the infinite GOP structure, in a case where one of the reception devices starts reproduction in such a system, the transmission device inserts an I picture as a reproduction start point for the reception device. This can be achieved by notifying the transmission device that the reception device starts reproduction.

However, for another reception device already performing reproduction, the I picture is inserted into a picture being reproduced. That is, a picture with low image quality appears in the middle of reproduced video, and there has been a possibility that degradation in the subjective image quality of a reproduced image thereof increases.

In a case where there is a plurality of reception devices as described above, it is conceivable that degrees of importance of the respective reception devices as transmission destinations of a video (moving image) are different from each other. For example, in the case of the image transmission system for performing live video production described above, a video transmitted to a system used for live broadcasting is viewed by a large number of customers almost as it is, whereas a video transmitted to a system used for confirmation (monitoring) may be viewed only by a worker at the site. Furthermore, a video transmitted to a system used for recording may be able to suppress degradation in the subjective image quality by image processing or editing after recording. Thus, the video transmitted to the system used for live broadcasting has a higher degree of importance of the subjective image quality than that of the video transmitted to the system used for confirmation or recording. That is, higher image quality is required. That is, it can be said that the reception device of the system used for live broadcasting has a higher degree of importance as the transmission destination of the video than the reception device of the system used for confirmation or recording.

For example, in such a system, it is assumed that a reception device of a system used for confirmation or recording is receiving (that is, reproducing) a bitstream and a reception device of a system used for live broadcasting starts reception (reproduction). In this case, for the reception device of the system used for confirmation or recording, an I picture is inserted in the middle of a reproduced video. That is, in this case, the subjective image quality is degraded in the reproduced video of the reception device with a low degree of importance. For that reason, it can be said that the influence of the reproduction start on the subjective image quality of the reproduced video is relatively small.

Conversely, it is assumed that the reception device of the system used for live broadcasting is receiving (that is, reproducing) a bitstream, and the reception device of the system used for confirmation or recording starts reception (reproduction). In this case, for the reception device of the system used for live broadcasting, an I picture is inserted in the middle of a reproduced video. That is, in this case, the subjective image quality of the reproduced video by the reception device with a high degree of importance is degraded by the reproduction start by the reception device with a low degree of importance. For that reason, it can be said that the influence of the reproduction start on the subjective image quality of the reproduced video is relatively large.

As described above, depending on the reception device that starts reproduction, there has been a possibility that the influence of the reproduction video on the subjective image quality is further increased.

Meanwhile, for example, Non-Patent Document 1 has disclosed a method of performing prioritization according to a degree of importance of data and preferentially transmitting a packet with a higher priority. Furthermore, for example, Non-Patent Document 2 has disclosed a method of assigning a priority to a packet according to a type of a picture (I picture, P picture, B picture) and selecting a packet to be transmitted according to the priority.

However, even if transmission and reception are controlled according to the degree of importance of the data or the picture as in these methods, it has been difficult to suppress degradation in the subjective image quality of the reproduced image due to the reproduction start as described above.

Thus, a generation method for a reproduction start point is controlled according to a reception device that starts reproduction.

### 3. First Embodiment

### <Image Transmission System>

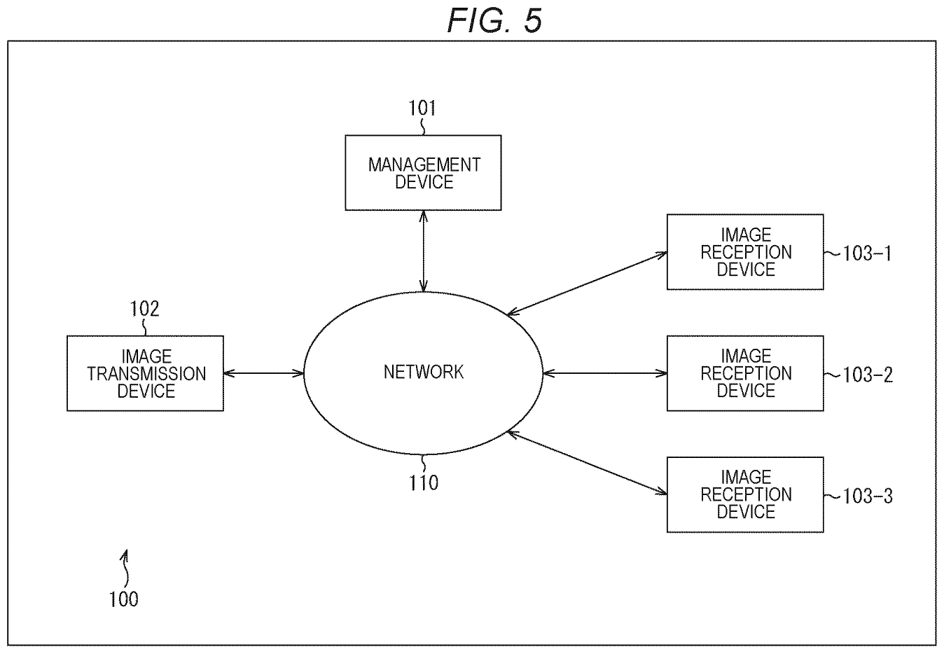

FIG. 5 is a block diagram illustrating an aspect of an image transmission system to which the present technology is applied. An image transmission system 100 illustrated in FIG. 5 is a system that transmits a moving image via a network 110. At that time, the image transmission system 100 encodes the moving image and transmits the moving image encoded as a bitstream. For example, the image transmission system 100 may be a system used for live video production. For example, the image transmission system 100 may be a system that transmits a moving image captured by a camera to a broadcast video production device.

Note that, FIG. 5 illustrates a main configuration including devices, data flows, and the like, and the devices and the dataflows illustrated in FIG. 5 are not necessarily all. That is, the image transmission system 100 may include a device or a processing unit not illustrated as a block in FIG. 5. Furthermore, there may be a data flow, processing, or the like that is not illustrated as an arrow or the like in FIG. 5.

As illustrated in FIG. 5, the image transmission system 100 includes a management device 101, an image transmission device 102, and an image reception device 103-1 to an image reception device 103-3. The image reception device 103-1 to the image reception device 103-3 will be referred to as an image reception device 103 in a case where it is not necessary to distinguish them from each other for explanation. The management device 101, the image transmission device 102, and the image reception device 103 are communicably connected to the network 110. That is, the management device 101, the image transmission device 102, and the image reception device 103 are communicably connected to each other via the network 110.

The management device 101 is a system manager that monitors the network 110 and detects the image transmission device 102 and the image reception device 103 (that is, a device participating in the image transmission system 100) connected to the network 110.

The image transmission device 102 is a transmission device that transmits a moving image to the image reception device 103 via the network 110. The image transmission device 102 may receive as an input a moving image captured by an imaging device (not illustrated) connected to the image transmission device 102 and transmit the input moving image to the image reception device 103. The image transmission device 102 includes an encoder for a moving image, encodes the moving image, and transmits the moving image encoded as a bitstream.

The image reception device 103 is a reception device that receives a moving image (bitstream) transmitted from the image transmission device 102 via the network 110. The image reception device 103 includes a decoder for a moving image, decodes a bitstream of the moving image, and reproduces the moving image. The image reception device 103-1 to the image reception device 103-3 can receive bitstreams identical to each other transmitted by the image transmission device 102.

The network 110 is a communication network serving as a communication medium between the devices. The network 110 may be a communication network of wired communication, or a communication network of wireless communication, or may include both of them. For example, the network 110 may be a wired local area network (LAN), a wireless LAN, a public telephone line network, a wide area communication network for a wireless mobile body such as a so-called 4G line or 5G line, the Internet, or the like, or a combination thereof. Furthermore, the network 110 may be a single communication network or a plurality of communication networks. Furthermore, for example, a part or all of the network 110 may be configured by a communication cable of a predetermined standard, for example, a universal serial bus (USB) (registered trademark) cable, a high-definition multimedia interface (HDMI) (registered trademark) cable, or the like.

Although one management device 101 is illustrated in FIG. 5, the number of management devices 101 included in the image transmission system 100 is any number. Similarly, the number of image transmission devices 102 and the number of image reception devices 103 are also any numbers. For example, the image transmission system 100 may include a plurality of management devices 101 and image transmission devices 102. Furthermore, the number of image reception devices 103 may be four or more, or two or less.

### <Management Device>

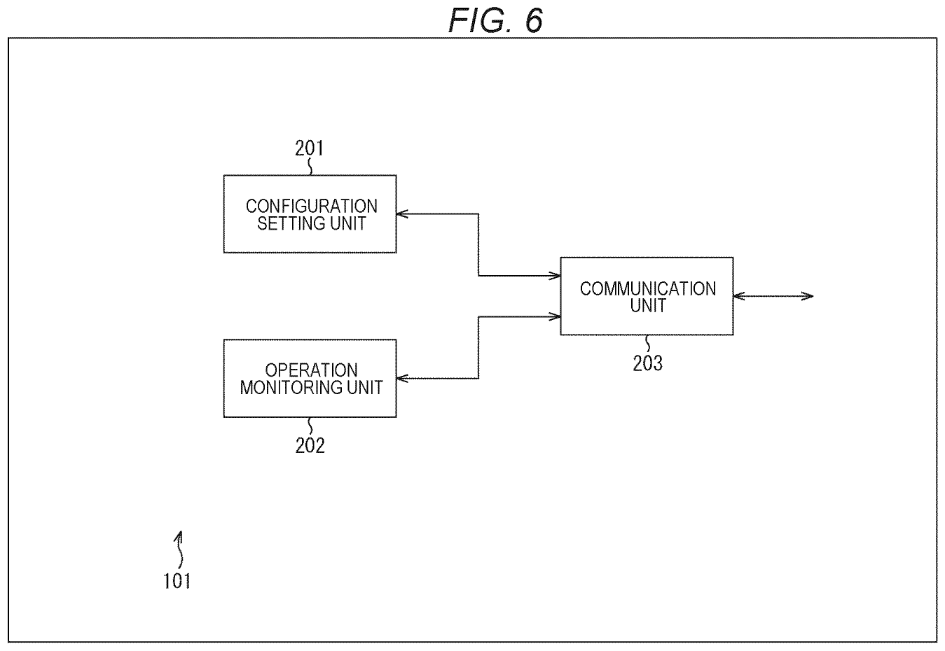

FIG. 6 is a block diagram illustrating a main configuration example of the management device 101. Note that FIG. 6 illustrates a main configuration including processing units, data flows, and the like, and the processing units and the data flows illustrated in FIG. 6 are not necessarily all. That is, the management device 101 may include a block (a processing unit or the like) not illustrated in FIG. 6. Furthermore, there may be a data flow or processing that is not illustrated as an arrow or the like in FIG. 6.

As illustrated in FIG. 6, the management device 101 includes a configuration setting unit 201, an operation monitoring unit 202, and a communication unit 203.

The configuration setting unit 201 performs processing related to configuration setting. For example, the configuration setting unit 201 may control the image transmission device 102 and the image reception device 103 via the communication unit 203 to set the configuration.

The operation monitoring unit 202 performs processing related to monitoring of the network 110. For example, the operation monitoring unit 202 may monitor the network 110 via the communication unit 203 at the time of operating the image transmission system 100. Then, the operation monitoring unit 202 may detect a change (for example, a new connection, disconnection, or the like) in the image transmission device 102 or the image reception device 103 connected to the network 110 (participating in the image transmission system 100).

The communication unit 203 executes processing related to communication with another device. For example, the communication unit 203 may exchange information with the image transmission device 102 and the image reception device 103 via the network 110. For example, the communication unit 203 may acquire information supplied from the configuration setting unit 201 or the operation monitoring unit 202 and transmit the information to the network 110. Furthermore, the communication unit 203 may receive information transmitted via the network 110 and supply the information to the configuration setting unit 201 and the operation monitoring unit 202.

### <Image Transmission Device>

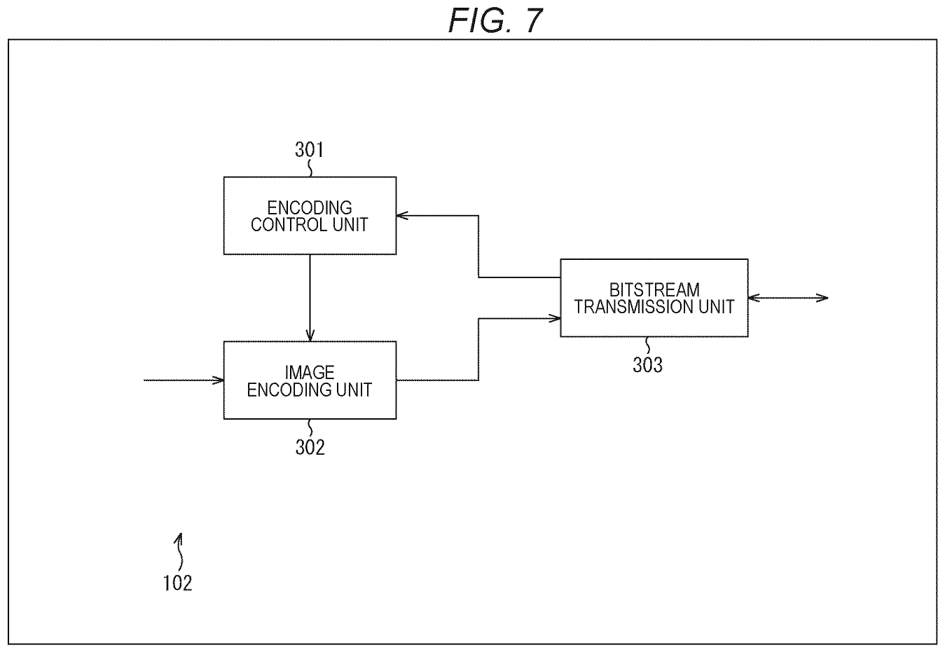

FIG. 7 is a block diagram illustrating a main configuration example of the image transmission device 102. Note that FIG. 7 illustrates a main configuration including processing units, data flows, and the like, and the processing units and the data flows illustrated in FIG. 7 are not necessarily all. That is, the image transmission device 102 may include a block (a processing unit or the like) not illustrated in FIG. 7. Furthermore, there may be a data flow or processing that is not illustrated as an arrow or the like in FIG. 7.

As illustrated in FIG. 7, the image transmission device 102 includes an encoding control unit 301, an image encoding unit 302, and a bitstream transmission unit 303.

The encoding control unit 301 executes processing related to control of encoding. For example, the encoding control unit 301 may control the image encoding unit 302. Furthermore, the encoding control unit 301 may acquire information transmitted from another device via the bitstream transmission unit 303. The encoding control unit 301 may store (hold) the information. The encoding control unit 301 may control the image encoding unit 302 on the basis of the information. For example, the encoding control unit 301 may set a reproduction start point for encoding of a moving image by the image encoding unit 302 on the basis of a request from the image reception device 103. Furthermore, the encoding control unit 301 may perform configuration setting related to encoding of a moving image by the image encoding unit 302 according to control of the management device 101 and hold the setting. Then, the encoding control unit 301 may control the image encoding unit 302 on the basis of the configuration setting.

The image encoding unit 302 executes processing related to encoding of a moving image. For example, the image encoding unit 302 may encode a moving image to be transmitted input to the image transmission device 102 and generate a bitstream including coded data of the moving image. At that time, the image encoding unit 302 may encode the moving image according to control of the encoding control unit 301. Note that the encoding method applied by the image encoding unit 302 is any method as long as it is an encoding method using intra prediction or inter prediction. For example, AVC (H.264), HEVC (H.265), VVC (H.266), or the like may be used. Furthermore, the image encoding unit 302 may supply the generated bitstream to the bitstream transmission unit 303.

The bitstream transmission unit 303 communicates with another device via the network 110 and executes processing related to transmission of a bitstream. For example, the bitstream transmission unit 303 may acquire a bitstream supplied from the image encoding unit 302 and transmit the bitstream to another device (for example, the image reception device 103) via the network 110. Furthermore, the bitstream transmission unit 303 may exchange information with another device via the network 110. For example, the bitstream transmission unit 303 may receive control by the management device 101 and supply the control to the encoding control unit 301. Furthermore, the bitstream transmission unit 303 may receive a request from the image reception device 103 and supply the request to the encoding control unit 301.

### <Image Encoding Unit>

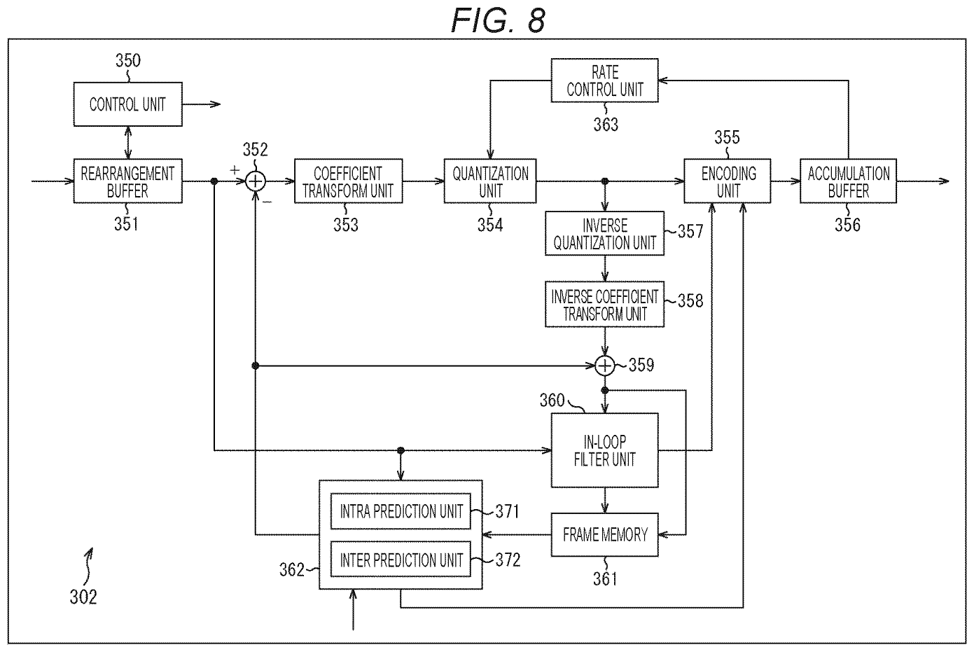

FIG. 8 is a block diagram illustrating an example of a main configuration of the image encoding unit 302. Note that FIG. 8 illustrates a main configuration including processing units, data flows, and the like, and the processing units and the data flows illustrated in FIG. 8 are not necessarily all. That is, the image encoding unit 302 may include a block (a processing unit or the like) not illustrated in FIG. 8. Furthermore, there may be a data flow or processing that is not illustrated as an arrow or the like in FIG. 8.

As illustrated in FIG. 8, the image encoding unit 302 includes a control unit 350, a rearrangement buffer 351, a calculation unit 352, a coefficient transform unit 353, a quantization unit 354, an encoding unit 355, and an accumulation buffer 356. Furthermore, the image encoding unit 302 includes an inverse quantization unit 357, an inverse coefficient transform unit 358, a calculation unit 359, an in-loop filter unit 360, a frame memory 361, a prediction unit 362, and a rate control unit 363. The prediction unit 362 includes an intra prediction unit 371 and an inter prediction unit 372.

### <Control Unit>

The control unit 350 executes processing related to control of encoding. For example, the control unit 350 may set blocks (CU, PU, transform block, and the like) of units of processing of moving image data held by the rearrangement buffer 351. Furthermore, the control unit 350 may divide the moving image data held by the rearrangement buffer 351 into the set blocks of units of processing. Furthermore, the control unit 350 may determine encoding parameters (header information Hinfo, prediction mode information Pinfo, transform information Tinfo, filter information Finfo, and the like) to be supplied to each block obtained by dividing the moving image data on the basis of, for example, rate-distortion optimization (RDO). Furthermore, the control unit 350 may supply the determined encoding parameters to each block (not illustrated). For example, the control unit 350 may supply the header information Hinfo to each block. Furthermore, the control unit 350 may supply the prediction mode information Pinfo to the encoding unit 355 and the prediction unit 362. Furthermore, the control unit 350 may supply the transform information Tinfo to the coefficient transform unit 353, the quantization unit 354, the encoding unit 355, the inverse quantization unit 357, and the inverse coefficient transform unit 358. Furthermore, the control unit 350 may supply the filter information Finfo to the in-loop filter unit 360.

### <Rearrangement Buffer>

Each of fields (input images) of the moving image data is input to the image encoding unit 302 in its reproduction order (display order). The rearrangement buffer 351 acquires and holds (stores) each of the input images in its reproduction order (display order). The rearrangement buffer 351 rearranges the input images in encoding order (decoding order) or divides the input images into blocks of units of processing on the basis of the control of the control unit 350. The rearrangement buffer 351 supplies each of input images after processing to the calculation unit 352.

### <Calculation Unit>

The calculation unit 352 subtracts a predicted image supplied from the prediction unit 362 from an image corresponding to a block of a unit of processing supplied from the rearrangement buffer 351 to derive a predicted residual, and supplies the predicted residual to the coefficient transform unit 353.

### <Coefficient Transform Unit>

The coefficient transform unit 353 uses the predicted residual supplied from the calculation unit 352 and the transform information Tinfo supplied from the control unit 350 as inputs, performs coefficient transform on the predicted residual on the basis of the transform information Tinfo, and derives a transform coefficient. The coefficient transform may be any transform. For example, orthogonal transform may be used. The coefficient transform unit 353 supplies the obtained transform coefficient to the quantization unit 354.

### <Quantization Unit>

The quantization unit 354 uses the transform coefficient supplied from the coefficient transform unit 353 and the transform information Tinfo supplied from the control unit 350 as inputs, and performs scaling (quantization) of the transform coefficient on the basis of the transform information Tinfo. Note that a rate of the quantization is controlled by the rate control unit 363. The quantization unit 354 supplies the transform coefficient after quantization (also referred to as a quantized transform coefficient level) obtained by such quantization to the encoding unit 355 and the inverse quantization unit 357.

### <Encoding Unit>

The encoding unit 355 uses, as inputs, various encoding parameters (header information Hinfo, prediction mode information Pinfo, transform information Tinfo, filter information Finfo, and the like) supplied from the control unit 350, information regarding a filter such as a filter coefficient supplied from the in-loop filter unit 360, and information regarding an optimum prediction mode supplied from the prediction unit 362.

Furthermore, the encoding unit 355 acquires the quantized transform coefficient level supplied from the quantization unit 354. The encoding unit 355 performs entropy encoding (lossless encoding), for example, Context-based Adaptive Binary Arithmetic Code (CABAC), Context-based Adaptive Variable Length Code (CAVLC), or the like on the acquired quantized transform coefficient level to generate a bit string (coded data). Furthermore, the encoding unit 355 derives residual information Rinfo from the quantized transform coefficient level, encodes the residual information Rinfo, and generates a bit string. Moreover, the encoding unit 355 includes the information regarding the filter supplied from the in-loop filter unit 360 in the filter information Finfo, and includes the information regarding the optimum prediction mode supplied from the prediction unit 362 in the prediction mode information Pinfo. Then, the encoding unit 355 encodes the above-described various encoding parameters (header information Hinfo, prediction mode information Pinfo, transform information Tinfo, filter information Finfo, and the like) to generate bit strings. Furthermore, the encoding unit 355 multiplexes bit strings of various types of information generated as described above to generate coded data. The encoding unit 355 supplies the coded data to the accumulation buffer 356.

### <Accumulation Buffer>

The accumulation buffer 356 temporarily holds the coded data obtained by the encoding unit 355. The accumulation buffer 356 supplies the held coded data to the bitstream transmission unit 303 as, for example, a bitstream or the like at a predetermined timing.

### <Inverse Quantization Unit>

The inverse quantization unit 357 performs processing related to inverse quantization. For example, the inverse quantization unit 357 uses the quantized transform coefficient level supplied from the quantization unit 354 and the transform information Tinfo supplied from the control unit 350 as inputs, and performs scaling (inverse quantization) of a value of the quantized transform coefficient level on the basis of the transform information Tinfo. Note that the inverse quantization is inverse processing of the quantization performed in the quantization unit 354. The inverse quantization unit 357 supplies a transform coefficient obtained by such inverse quantization to the inverse coefficient transform unit 358. Note that, since the inverse quantization unit 357 is similar to an inverse quantization unit on the decoding side (described later), a description (described later) to be given for the decoding side can be applied to the inverse quantization unit 357.

### <Inverse Coefficient Transform Unit>

The inverse coefficient transform unit 358 performs processing related to inverse coefficient transform. For example, the inverse coefficient transform unit 358 uses the transform coefficient supplied from the inverse quantization unit 357 and the transform information Tinfo supplied from the control unit 350 as inputs, performs inverse coefficient transform on the transform coefficient on the basis of the transform information Tinfo, and derives a predicted residual. Note that the inverse coefficient transform is inverse processing of the coefficient transform performed in the coefficient transform unit 353. For example, inverse orthogonal transform, which is inverse processing of orthogonal transform, may be performed as the inverse coefficient transform. The inverse coefficient transform unit 358 supplies the predicted residual obtained by such inverse coefficient transform to the calculation unit 359. Note that since the inverse coefficient transform unit 358 is similar to an inverse coefficient transform unit on the decoding side (described later), a description (described later) to be given for the decoding side can be applied to the inverse coefficient transform unit 358.

### <Calculation Unit>

The calculation unit 359 uses, as inputs, the predicted residual supplied from the inverse coefficient transform unit 358 and the predicted image supplied from the prediction unit 362. The calculation unit 359 adds the predicted residual and the predicted image corresponding to the predicted residual together to derive a locally decoded image. The calculation unit 359 supplies the derived locally decoded image to the in-loop filter unit 360 and the frame memory 361.

### <In-Loop Filter Unit>

The in-loop filter unit 360 performs processing related to in-loop filter processing. For example, the in-loop filter unit 360 uses, as inputs, the locally decoded image supplied from the calculation unit 359, the filter information Finfo supplied from the control unit 350, and the input image (original image) supplied from the rearrangement buffer 351. Note that information input to the in-loop filter unit 360 is any information, and information other than these pieces of information may be input. For example, a prediction mode, motion information, a code amount target value, a quantization parameter QP, a picture type, information on a block (CU, CTU, or the like), or the like may be input to the in-loop filter unit 360, as necessary.

The in-loop filter unit 360 appropriately performs filtering processing on the locally decoded image on the basis of the filter information Finfo. The in-loop filter unit 360 also uses the input image (original image) or other input information for the filtering processing, as necessary.

For example, the in-loop filter unit 360 can apply four in-loop filters of a bilateral filter, a deblocking filter (DBF), an adaptive offset filter (sample adaptive offset (SAO)), and an adaptive loop filter (ALF) in this order. Note that, which filers are applied and in what order the filters are applied can be arbitrarily and appropriately selected.

Of course, the filter processing performed by the in-loop filter unit 360 is any processing and is not limited to the above example. For example, the in-loop filter unit 360 may apply a wiener filter or the like.

The in-loop filter unit 360 supplies the locally decoded image subjected to the filter processing to the frame memory 361. Note that, for example, in a case where information regarding a filter such as a filter coefficient is transmitted to the decoding side, the in-loop filter unit 360 supplies the information regarding the filter to the encoding unit 355.

### <Frame Memory>

The frame memory 361 performs processing related to storage of data related to an image. For example, the frame memory 361 uses the locally decoded image supplied from the calculation unit 359 or the locally decoded image subjected to the filter processing supplied from the in-loop filter unit 360 as an input, and holds (stores) the locally decoded image. Furthermore, the frame memory 361 reconstructs a decoded image for each picture unit by using the locally decoded image, and holds the decoded image (in a buffer in the frame memory 361). The frame memory 361 supplies the decoded image (or a part thereof) to the prediction unit 362 in response to a request from the prediction unit 362.

### <Prediction Unit>

The prediction unit 362 performs processing related to generation of a predicted image. For example, the prediction unit 362 uses, as inputs, the prediction mode information Pinfo supplied from the control unit 350, the input image (original image) supplied from the rearrangement buffer 351, and the decoded image (or a part thereof) read from the frame memory 361. The prediction unit 362 uses the prediction mode information Pinfo and the input image (original image) to perform prediction with reference to the decoded image as a reference image, performs motion compensation processing on the basis of a result of the prediction, and generates a predicted image. For example, the intra prediction unit 371 performs intra prediction to generate a predicted image. Furthermore, the inter prediction unit 372 performs inter prediction to generate a predicted image. The prediction unit 362 supplies the generated predicted image to the calculation unit 352 and the calculation unit 359. Furthermore, the prediction unit 362 supplies information regarding the prediction mode selected by the above processing, that is, the optimum prediction mode, to the encoding unit 355, as necessary.

### <Rate Control Unit>

The rate control unit 363 performs processing related to rate control. For example, the rate control unit 363 controls a rate of quantization operation of the quantization unit 354 so that overflow or underflow does not occur on the basis of a code amount of the coded data accumulated in the accumulation buffer 356. For example, the rate control unit 363 sets a quantization parameter (PictureQp) for the entire picture. Furthermore, the rate control unit 363 supplies the quantization parameter (PictureQp) to the quantization unit 354 and the like.

### <Image Reception Device>

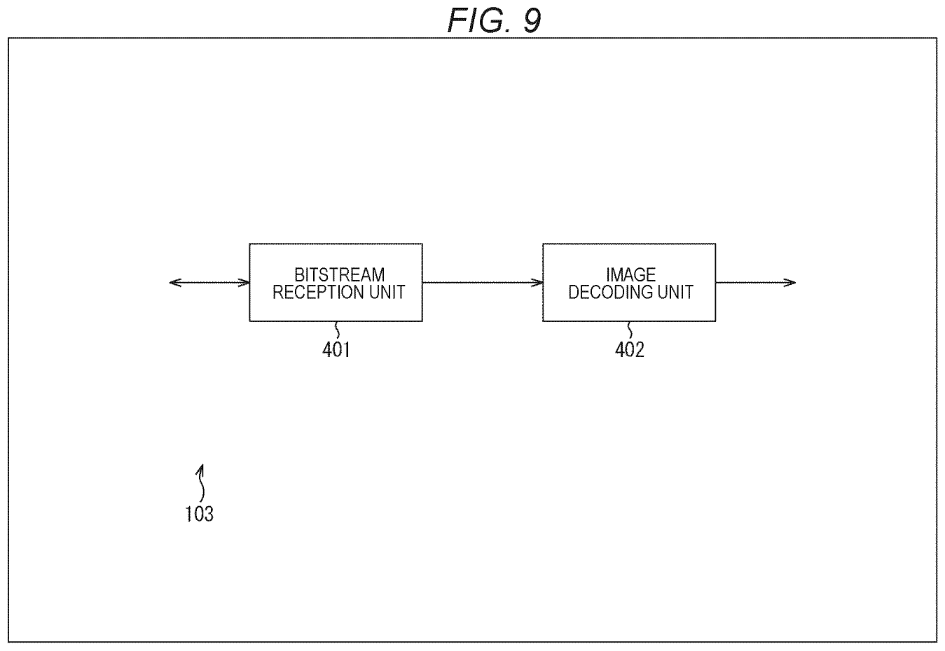

FIG. 9 is a block diagram illustrating a main configuration example of the image reception device 103. Note that FIG. 9 illustrates a main configuration including processing units, data flows, and the like, and the processing units and the data flows illustrated in FIG. 9 are not necessarily all. That is, the image reception device 103 may include a block (a processing unit or the like) not illustrated in FIG. 9. Furthermore, there may be a data flow or processing that is not illustrated as an arrow or the like in FIG. 9.

As illustrated in FIG. 9, the image reception device 103 includes a bitstream reception unit 401 and an image decoding unit 402.

The bitstream reception unit 401 communicates with another device via the network 110 and executes processing related to reception of a bitstream. For example, the bitstream reception unit 401 may receive a bitstream transmitted from another device (for example, the image transmission device 102) via the network 110 and supply the bitstream to the image decoding unit 402. Furthermore, the bitstream reception unit 401 may exchange information with another device via the network 110. For example, the bitstream reception unit 401 may receive control by the management device 101, perform configuration setting related to reception of the bitstream according to the control, and hold the setting. Furthermore, the bitstream reception unit 401 may request the image transmission device 102 to generate a reproduction start point.

The image decoding unit 402 executes processing related to decoding of a moving image. For example, the image decoding unit 402 may decode the bitstream supplied from the bitstream reception unit 401 to generate (restore) a moving image, and reproduce the moving image. Note that the decoding method applied by the image decoding unit 402 is any decoding method as long as it is compatible with the encoding method applied by the image encoding unit 302 of the image transmission device 102 (that is, as long as it is a method using intra prediction or inter prediction is used). For example, AVC (H.264), HEVC (H.265), VVC (H.266), or the like may be used. Furthermore, the image decoding unit 402 may output the generated moving image to the outside of the image reception device 103.

### <Image Decoding Unit>

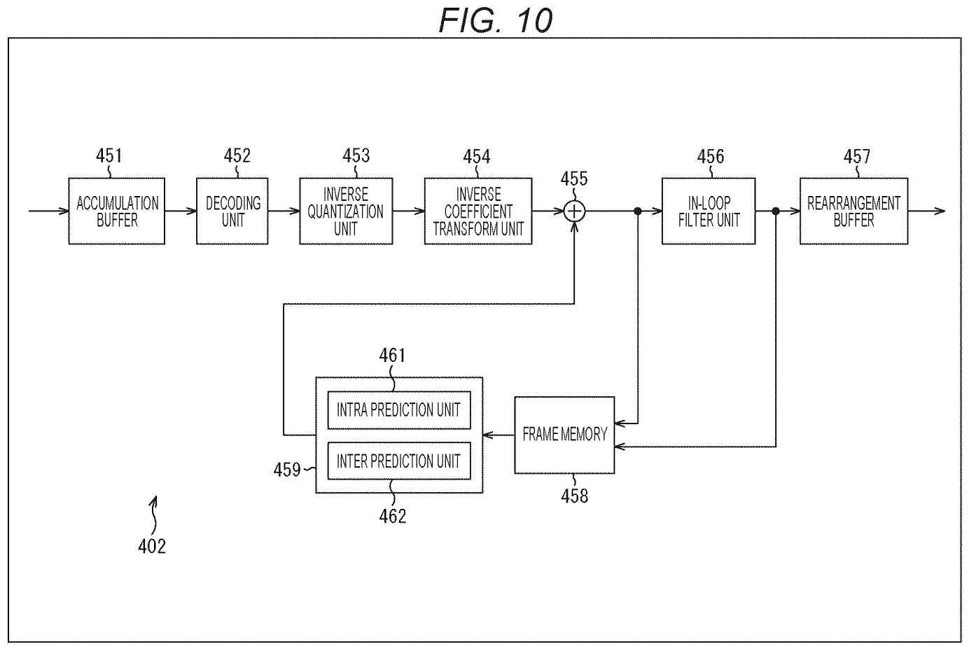

FIG. 10 is a block diagram illustrating an example of a main configuration of the image decoding unit 402. Note that FIG. 10 illustrates a main configuration including processing units, data flows, and the like, and the processing units and the data flows illustrated in FIG. 10 are not necessarily all. That is, the image decoding unit 402 may include a block (a processing unit or the like) not illustrated in FIG. 10. Furthermore, there may be a data flow or processing that is not illustrated as an arrow or the like in FIG. 10.

As illustrated in FIG. 10, the image decoding unit 402 includes an accumulation buffer 451, a decoding unit 452, an inverse quantization unit 453, an inverse coefficient transform unit 454, a calculation unit 455, an in-loop filter unit 456, a rearrangement buffer 457, a frame memory 458, and a prediction unit 459. The prediction unit 459 includes an intra prediction unit 461 and an inter prediction unit 462.

### <Accumulation Buffer>

The accumulation buffer 451 acquires and holds (stores) the bitstream input to the image decoding unit 402. The accumulation buffer 451 supplies the accumulated bitstream to the decoding unit 452 at a predetermined timing or in a case where, for example, a predetermined condition is satisfied.

### <Decoding Unit>

The decoding unit 452 performs processing related to decoding of an image. For example, the decoding unit 452 uses the bitstream supplied from the accumulation buffer 451 as an input, performs entropy decoding (lossless decoding) on a syntax value of each of syntax elements from the bit string according to a definition of a syntax table, and derives a parameter.

Parameters derived from a syntax element and a syntax value of the syntax element include information, for example, the header information Hinfo, the prediction mode information Pinfo, the transform information Tinfo, the residual information Rinfo, the filter information Finfo, and the like. That is, the decoding unit 452 parses (analyzes and acquires) these pieces of information from the bitstream.

The decoding unit 452 derives a quantized transform coefficient level at each of coefficient positions in each of transform blocks with reference to the residual information Rinfo. The decoding unit 452 supplies the quantized transform coefficient level to the inverse quantization unit 453. Furthermore, the decoding unit 452 supplies the parsed header information Hinfo, prediction mode information Pinfo, transform information Tinfo, and filter information Finfo to each block.

For example, the decoding unit 452 supplies the header information Hinfo to the inverse quantization unit 453, the inverse coefficient transform unit 454, the prediction unit 459, and the in-loop filter unit 456. Furthermore, the decoding unit 452 supplies the prediction mode information Pinfo to the inverse quantization unit 453 and the prediction unit 459. Furthermore, the decoding unit 452 supplies the transform information Tinfo to the inverse quantization unit 453 and the inverse coefficient transform unit 454. Furthermore, the decoding unit 452 supplies the filter information Finfo to the in-loop filter unit 456. Of course, these are examples, and supply destinations of the encoding parameters are not limited to the examples. For example, each encoding parameter may be supplied to any processing unit. Furthermore, other information may be supplied to any processing unit.

### <Inverse Quantization Unit>

The inverse quantization unit 453 performs processing related to inverse quantization. For example, the inverse quantization unit 453 uses the transform information Tinfo and the quantized transform coefficient level supplied from the decoding unit 452 as inputs, performs scaling (inverse quantization) of the value of the quantized transform coefficient level on the basis of the transform information Tinfo, and derives a transform coefficient after inverse quantization. Note that the inverse quantization is performed as inverse processing of the quantization by the quantization unit 354. Furthermore, the inverse quantization is processing similar to the inverse quantization by the inverse quantization unit 357. That is, the inverse quantization unit 357 performs processing (inverse quantization) similar to that by the inverse quantization unit 453. The inverse quantization unit 453 supplies the derived transform coefficient to the inverse coefficient transform unit 454.

### <Inverse Coefficient Transform Unit>

The inverse coefficient transform unit 454 performs processing related to inverse coefficient transform. For example, the inverse coefficient transform unit 454 uses the transform coefficient supplied from the inverse quantization unit 453 and the transform information Tinfo supplied from the decoding unit 452 as inputs, performs inverse coefficient transform processing, for example, inverse orthogonal transform or the like, on the transform coefficient on the basis of the transform information Tinfo, and derive a predicted residual. Note that the inverse coefficient transform is performed as inverse processing of the coefficient transform by the coefficient transform unit 353. Furthermore, the inverse coefficient transform is processing similar to the inverse coefficient transform by the inverse coefficient transform unit 358. That is, the inverse coefficient transform unit 358 performs processing (inverse coefficient transform) similar to that by the inverse coefficient transform unit 454. The inverse coefficient transform unit 454 supplies the derived predicted residual to the calculation unit 455.

### <Calculation Unit>

The calculation unit 455 performs processing related to addition of information regarding an image. For example, the calculation unit 455 uses the predicted residual supplied from the inverse coefficient transform unit 454 and the predicted image supplied from the prediction unit 459 as inputs. The calculation unit 455 adds the predicted residual and the predicted image (predicted signal) corresponding to the predicted residual together to derive a locally decoded image. The calculation unit 455 supplies the derived locally decoded image to the in-loop filter unit 456 and the frame memory 458.

### <In-Loop Filter Unit>

The in-loop filter unit 456 performs processing related to in-loop filter processing. For example, the in-loop filter unit 456 uses the locally decoded image supplied from the calculation unit 455 and the filter information Finfo supplied from the decoding unit 452 as inputs. Note that the information input to the in-loop filter unit 456 is any information, and information other than these pieces of information may be input.

The in-loop filter unit 456 appropriately performs filtering processing on the locally decoded image on the basis of the filter information Finfo. For example, the in-loop filter unit 456 applies four in-loop filters of a bilateral filter, a deblocking filter (DBF), an adaptive offset filter (sample adaptive offset (SAO)), and an adaptive loop filter (ALF) in this order. Note that, which filers are applied and in what order the filters are applied can be arbitrarily and appropriately selected.

The in-loop filter unit 456 performs filtering processing corresponding to the filtering processing performed by the encoding side (for example, the in-loop filter unit 360). Of course, the filter processing performed by the in-loop filter unit 456 is any processing and is not limited to the above example. For example, the in-loop filter unit 456 may apply a wiener filter or the like. The in-loop filter unit 456 supplies the locally decoded image subjected to the filtering processing to the rearrangement buffer 457 and the frame memory 458.

### <Rearrangement Buffer>

The rearrangement buffer 457 uses the locally decoded image supplied from the in-loop filter unit 456 as an input, and holds (stores) the locally decoded image. Furthermore, the rearrangement buffer 457 reconstructs a decoded image for each picture unit by using the locally decoded image, and holds the decoded image (in a buffer). The rearrangement buffer 457 rearranges obtained decoded images in decoding order to reproduction order. The rearrangement buffer 457 outputs a rearranged decoded image group to the outside of the image decoding unit 402 (image reception device 103) as moving image data.

### <Frame Memory>

The frame memory 458 performs processing related to storage of data related to an image. For example, the frame memory 458 uses the locally decoded image supplied from the calculation unit 455 as an input, reconstructs the decoded image for each picture unit, and stores the decoded image in a buffer in the frame memory 458. Furthermore, the frame memory 458 uses the locally decoded image subjected to the in-loop filter processing supplied from the in-loop filter unit 456 as an input, reconstructs the decoded image for each picture unit, and stores the decoded image in a buffer in the frame memory 458. The frame memory 458 appropriately supplies the stored decoded image (or a part thereof) to the prediction unit 459 as a reference image. Note that the frame memory 458 may store the header information Hinfo, the prediction mode information Pinfo, the transform information Tinfo, the filter information Finfo, and the like related to generation of the decoded image.

### <Prediction Unit>

The prediction unit 459 performs processing related to generation of a predicted image. For example, the prediction unit 459 uses the prediction mode information Pinfo supplied from the decoding unit 452 as an input, performs prediction by a prediction method specified by the prediction mode information Pinfo, and derives a predicted image. For example, in a case where intra prediction is applied in the image encoding unit 302, the intra prediction unit 461 derives a predicted image by using the intra prediction. Furthermore, in a case where inter prediction is applied in the image encoding unit 302, the inter prediction unit 462 derives a predicted image by using the inter prediction. At the time of derivation, the prediction unit 419 uses the decoded image (or a part thereof) before filtering or after filtering stored in the frame memory 458, specified by the prediction mode information Pinfo, as the reference image. The prediction unit 459 supplies the derived predicted image to the calculation unit 455.

### <Control of Reproduction Start Point Generation Method>

In the image transmission system 100 having such a configuration, the image transmission device 102 sets a generation method for a reproduction start point according to the image reception device 103 that starts reproduction.

For example, in the image transmission device 102, the image encoding unit 302 encodes an image and generates a bitstream, the bitstream transmission unit 303 transmits the bitstream to a plurality of the image reception devices 103, and the encoding control unit 301 sets a generation method for a reproduction start point according to the image reception device 103 that starts reproduction, and controls the image encoding unit 302 to generate the reproduction start point by the set generation method.

For example, the encoding control unit 301 may apply intra refresh for a predetermined period as a reproduction start point for an image reception device 103 other than a specific image reception device 103 among the plurality of image reception devices 103. That is, in a case where generation of a reproduction start point is requested from the image reception device 103 other than the specific image reception device 103, the image encoding unit 302 may insert intra refresh for a predetermined period as the reproduction start point according to the control of the encoding control unit 301. For example, the encoding control unit 301 may apply an intra-coded picture as the reproduction start point for the image reception device 103 to which a moving image used for broadcasting is transmitted among the plurality of image reception devices 103, and may apply intra refresh for a predetermined period as the reproduction start point for another image reception device 103 to which a moving image used for other than broadcasting is transmitted.

Furthermore, the encoding control unit 301 may apply an intra-coded picture as a reproduction start point for the specific image reception device 103 among the plurality of image reception devices 103. That is, in a case where generation of a reproduction start point is requested from the specific image reception device 103, the image encoding unit 302 may insert an intra-coded picture (for example, an Instantaneous Decoder Refresh (IDR) picture or an I picture.) as the reproduction start point according to the control of the encoding control unit 301.

By doing so, it is possible to suppress image quality degradation due to the reproduction start.

For example, the image transmission system 100 may include the image transmission device 102 that transmits a bitstream including coded data of an image, and a plurality of the image reception devices 103 capable of receiving bitstreams identical to each other transmitted from the image transmission device 102, in which in the image transmission device 102 of the image transmission system 100, the image encoding unit 302 may encode the image to generate the bitstream, the bitstream transmission unit 303 may transmit the bitstream to the plurality of image reception devices 103, and the encoding control unit 301 may set a generation method for a reproduction start point according to the image reception device 103 that starts reproduction, and control the image encoding unit 302 to generate a reproduction start point by the set generation method. Furthermore, in the reception device, when starting reproduction, the bitstream reception unit 401 may request the image transmission device 102 to generate a reproduction start point, and receive a bitstream transmitted from the image transmission device 102, and the image decoding unit 402 may decode the bitstream to generate an image.

Note that the specification of the intra refresh is any specification. For example, the shape of the I slice to be inserted into the P picture (or the B picture) is any shape. A vertical strip type may be used in which a picture is divided into a plurality of parts in the horizontal direction as in the example of FIG. 2, or a horizontal strip type may be used in which a picture is divided into a plurality of parts in the vertical direction. Furthermore, a rectangular type may be used in which a picture is divided into a plurality of parts in the vertical direction and the horizontal direction. Furthermore, each I slice may be inserted into each picture of the refresh cycle in any order. For example, in the case of FIG. 2, each I slice is inserted in the order from the leftmost I slice to the rightmost I slice of the picture, but each I slice may be inserted in the order from the rightmost I slice to the leftmost I slice, or each I slice may be inserted in random order. This similarly applies to other shapes of the I slice. Furthermore, the number of I slices inserted into one picture is any number. For example, a plurality of I slices may be inserted into one picture.

Furthermore, the specific image reception device 103 may be any image reception device 103. A method of setting the specific image reception device is any method. For example, the most important image reception device 103 among the image reception devices 103 may be the specific image reception device 103. A method of setting a degree of importance of each image reception device 103 is any method. For example, the degree of importance may be set on the basis of a model, a model number, individual identification information (for example, MAC address, serial number, or the like), or the like of the image reception device 103. Furthermore, the degree of importance may be set on the basis of the performance or application of the image reception device 103. For example, for the image reception device 103 of a system in which a received moving image is used for live broadcasting, a higher degree of importance is set than that of the image reception device 103 in which a received moving image is used for other applications (confirmation and recording). With this setting, it is possible to suppress degradation in subjective image quality of a reproduced video in live broadcasting that is required to have higher image quality. Furthermore, the degree of importance may be set on the basis of the order of connection to the network 110. Furthermore, the degree of importance may be set on the basis of the configuration in the image transmission system 100. For example, the degree of importance may be set according to whether the image reception device 103 is connected to an internal network of an organization or a network outside the organization, or the like. Furthermore, the degree of importance may be set on the basis of available bandwidth or the like of a communication path between the image transmission device 102 and the image reception device 103. As described above, the specific image reception device 103 may be set on the basis of any condition related to the image reception device 103.

Setting (most important reception device setting) of the specific image reception device 103 may be performed before transmission of the bitstream. For example, at the time of configuration setting for the image transmission system 100, the setting of the specific image reception device 103 may be performed. Furthermore, the most important reception device setting may be performed during transmission of the bitstream. That is, the specific image reception device 103 may dynamically change in the time direction. That is, the most important reception device setting can be updated. The update timing is any timing. For example, in a case where the configuration of the image reception device 103 participating in the image transmission system 100 changes, the most important reception device setting may be updated to correspond to the latest configuration. Furthermore, even if the configuration of the image reception device 103 participating in the image transmission system 100 has not changed, the most important reception device setting may be updatable. For example, the most important reception device setting may be updatable in response to a request from some device. Furthermore, the most important reception device setting may be updated every predetermined time. Furthermore, the most important reception device setting may be updated at a predetermined time. Furthermore, the most important reception device setting may be updated in a predetermined situation (state).

Note that setting of the specific image reception device 103 (most important reception device setting) may be performed by any device. For example, the management device 101 may perform the most important reception device setting.

For example, the configuration setting unit 201 of the management device 101 sets the specific image reception device 103 from among the plurality of image reception devices 103 capable of receiving the bitstreams identical to each other transmitted from the image transmission device 102.

Note that, for example, in a case where the operation monitoring unit 202 monitors the network 110 and detects the update of the image reception device 103 capable of receiving the bitstream, the configuration setting unit 201 may set the specific image reception device 103.

By doing so, it is possible to perform setting (most important reception device setting) of the specific image reception device 103. Thus, as described above, the image transmission device 102 can set the generation method for a reproduction start point according to the image reception device 103 that starts reproduction, and can suppress image quality degradation due to the reproduction start. Furthermore, the most important reception device setting can be updated.

Note that the setting (most important reception device setting) of the specific image reception device 103 may be held by any device. For example, the management device 101 may store (hold) the most important reception device setting. In this case, the generation method for a reproduction start point may be set in the following flow. For example, when the image reception device 103 requests the image transmission device 102 to generate a reproduction start point, the image transmission device 102 inquires of the management device 101 the image reception device 103 that is the request source. The management device 101 determines whether or not the retrieved image reception device 103 is the specific image reception device 103 (most important reception device) on the basis of the stored most important reception device setting, and returns a result of the determination to the image transmission device 102. The image transmission device 102 sets a generation method for a reproduction start point on the basis of the result of the determination.

That is, for example, the configuration setting unit 201 of management device 101 may hold specific reception device information indicating the set specific reception device, and determine whether or not the image reception device 103 retrieved from the image transmission device 102 is the specific image reception device 103 on the basis of the held specific reception device information. Then, the communication unit 203 may transmit a result of the determination to the image transmission device 102 as a query source.

Furthermore, for example, the encoding control unit 301 of the image transmission device 102 may set the generation method for a reproduction start point on the basis of information (result of the determination by the management device 101) indicating whether or not the image reception device 103 that starts reproduction is the specific image reception device 103, provided from the management device 101.

Furthermore, for example, the image transmission device 102 may store (hold) the most important reception device setting. In this case, the generation method for a reproduction start point may be set in the following flow. For example, the management device 101 transmits the most important reception device setting to the image transmission device 102, and the image transmission device 102 stores (holds) the most important reception device setting. When the image reception device 103 requests the image transmission device 102 to generate a reproduction start point, the image transmission device 102 determines whether or not the image reception device 103 of the request source is the specific image reception device 103 (most important reception device) on the basis of the stored most important reception device setting, and sets the generation method for a reproduction start point on the basis of a result of the determination.

That is, for example, the configuration setting unit 201 of the management device 101 may transmit the specific reception device information indicating the set specific image reception device 103 to the image transmission device 102 via the communication unit 203.

In this case, for example, the encoding control unit 301 of the image transmission device 102 may hold the specific reception device information, determine whether the image reception device 103 that starts reproduction matches the specific reception device information, and set the generation method for a reproduction start point on the basis of a result of the determination.

Furthermore, for example, the image reception device 103 may store (hold) the most important reception device setting. In this case, the generation method for a reproduction start point may be set in the following flow. For example, the management device 101 transmits the most important reception device setting to the image reception device 103. The image reception device 103 stores (holds) information indicating whether or not the image reception device 103 itself is the specific image reception device 103 on the basis of the most important reception device setting. When requesting the image transmission device 102 to generate a reproduction start point, the image reception device 103 transmits the held information to the image transmission device 102. The image transmission device 102 determines whether or not the image reception device 103 of the request source is the specific image reception device 103 (most important reception device) on the basis of the information transmitted together with the request, and sets the generation method for a reproduction start point on the basis of a result of the determination.

That is, for example, the configuration setting unit 201 of the management device 101 may transmit the specific reception device information indicating the set specific image reception device 103 to the image reception device 103 via the communication unit 203.

Furthermore, for example, the bitstream reception unit 401 of the image reception device 103 may hold information indicating whether or not the image reception device 103 itself is the specific image reception device 103, and when starting reproduction, may provide the information to the image transmission device 102 and request generation of a reproduction start point. Then, the bitstream reception unit 401 may receive a bitstream after the reproduction start point inserted on the basis of the request, transmitted from the image transmission device 102. Furthermore, the image decoding unit 402 may decode the received bitstream to generate (restore) an image.

Note that the bitstream reception unit 401 may receive the specific reception device information transmitted from the management device 101, and generate and store (hold) information indicating whether or not the image reception device 103 itself is the specific image reception device 103 on the basis of the most important reception device setting.

In this case, the encoding control unit 301 of the image transmission device 102 may set the generation method for a reproduction start point on the basis of, for example, information (information indicating whether or not the image reception device 103 that starts reproduction itself is the specific image reception device 103) provided from the image reception device 103 that starts reproduction.

### <Flow of Setting Processing>

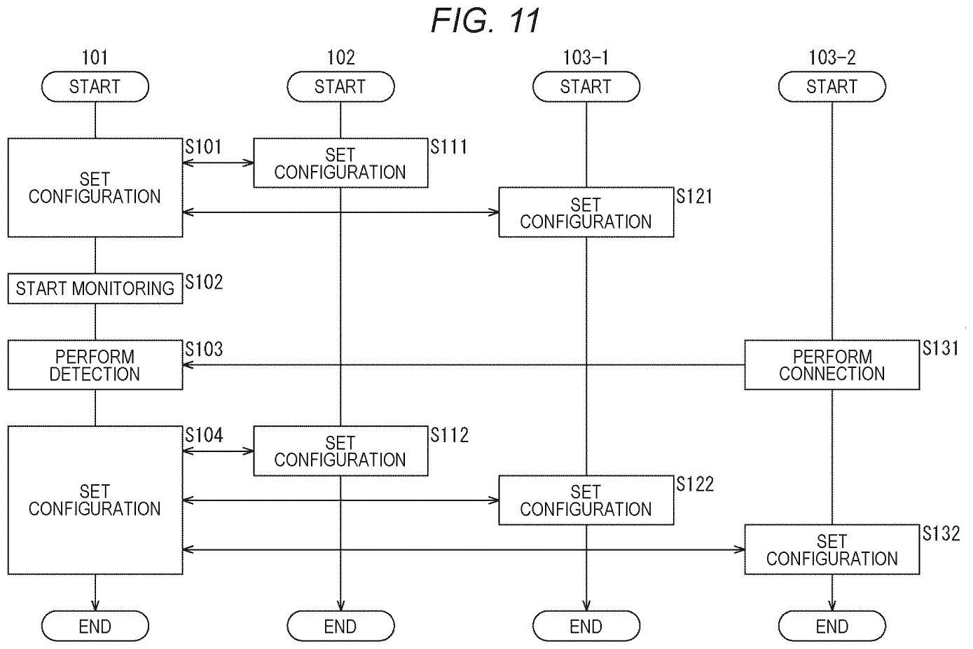

An example of a flow of setting processing of setting the specific image reception device 103 described above will be described with reference to a flowchart of FIG. 11. For example, in an initial state, it is assumed that the management device 101, the image transmission device 102, and the image reception device 103-1 are connected to the network 110 (participate in the image transmission system 100). As described above, the setting of the specific image reception device 103 can be performed before the bitstream is transmitted.

In step S101, the configuration setting unit 201 of the management device 101 communicates with the image transmission device 102 and the image reception device 103-1 via the communication unit 203, and sets configurations of the image transmission device 102 and the image reception device 103-1. In step S111, the encoding control unit 301 of the image transmission device 102 communicates with the management device 101 via the bitstream transmission unit 303 to set the configuration. In step S121, the bitstream reception unit 401 of the image reception device 103-1 communicates with the management device 101 to set the configuration.

In the processing, the configuration setting unit 201 of the management device 101 sets the specific image reception device 103. The setting is stored (held) in at least one of the management device 101, the image transmission device 102, or the image reception device 103-1.

When configuration setting is completed, transmission of the bitstream is started. In step S102, the operation monitoring unit 202 of the management device 101 starts monitoring the network 110. For example, when the image reception device 103-2 is connected to the network 110 in step S131, the operation monitoring unit 202 detects the connection (that is, the image reception device 103-2).

Since the configuration of the image reception device 103 participating in the image transmission system 100 has changed, configuration setting is performed.

In step S104, the configuration setting unit 201 of the management device 101 communicates with the image transmission device 102, the image reception device 103-1, and the image reception device 103-2 via the communication unit 203, and sets configurations. In step S112, the encoding control unit 301 of the image transmission device 102 communicates with the management device 101 via the bitstream transmission unit 303 to set the configuration. In step S122, the bitstream reception unit 401 of the image reception device 103-1 communicates with the management device 101 to set the configuration. In step S132, the bitstream reception unit 401 of the image reception device 103-2 communicates with the management device 101 to set the configuration.

Also in the processing, the configuration setting unit 201 of the management device 101 sets the specific image reception device 103. The setting is stored (held) in at least one of the management device 101, the image transmission device 102, the image reception device 103-1, or the image reception device 103-2.

By doing so, it is possible to dynamically change (update) the specific image reception device 103 in the time direction.

### <Flow of Image Transmission Processing>

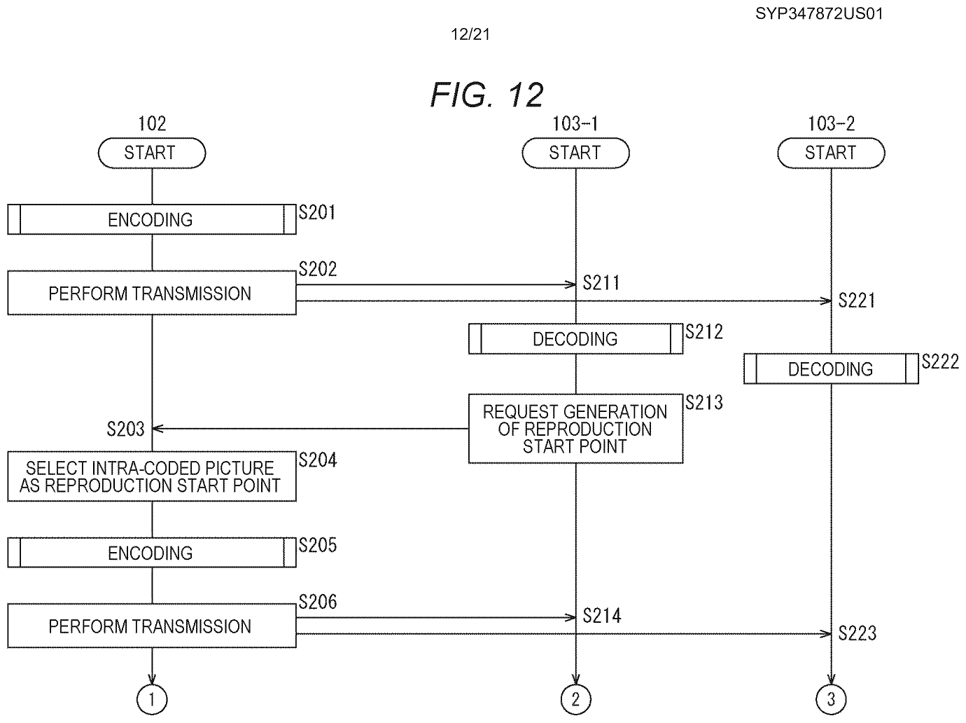

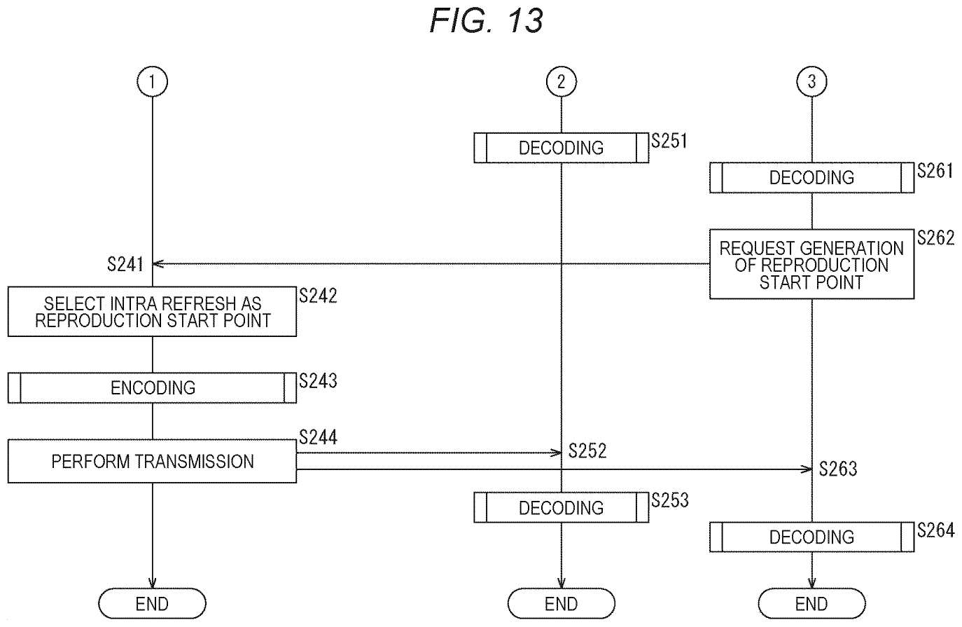

Next, an example of a flow of image transmission processing of transmitting an image (bitstream) will be described with reference to flowcharts of FIGS. 12 and 13. Note that, here, as an example, a case will be described where a bitstream is transmitted from the image transmission device 102 to the image reception device 103-1 and the image reception device 103-2. Furthermore, it is assumed that, among the image reception device 103-1 and the image reception device 103-2, the image reception device 103-1 is the specific image reception device 103 (most important reception device). In other words, it is assumed that the image reception device 103-2 is the image reception device 103 (non-most important reception device) other than the specific image reception device 103.

In step S201, the image encoding unit 302 of the image transmission device 102 encodes a moving image to generate a bitstream. In step S202, the bitstream transmission unit 303 transmits the bitstream to the image reception device 103-1 and the image reception device 103-2. In step S211, the bitstream reception unit 401 of the image reception device 103-1 receives the bitstream transmitted from the image transmission device 102. In step S212, the image decoding unit 402 of the image reception device 103-1 decodes the received bitstream. Similarly, in step S221, the bitstream reception unit 401 of the image reception device 103-2 receives the bitstream transmitted from the image transmission device 102. In step S222, the image decoding unit 402 of the image reception device 103-2 decodes the received bitstream.

For example, it is assumed that the image reception device 103-1 fails to receive the bitstream for some reason. In order to resume reception (reproduction), the bitstream reception unit 401 of the image reception device 103-1 requests the image transmission device 102 to generate a reproduction start point in step S213. The bitstream transmission unit 303 of the image transmission device 102 receives the request in step S203.

In step S204, the encoding control unit 301 of the image transmission device 102 sets a generation method for a reproduction start point according to whether or not the request source is the specific image reception device 103. A method of determining whether or not the request source is the specific image reception device 103 is any method, as described above. For example, an inquiry may be made to the management device 101, determination may be made on the basis of the most important reception device setting held by the encoding control unit 301, or determination may be made on the basis of information supplied from the request source. Since the image reception device 103-1 as the request source is the specific image reception device 103 (most important reception device), the encoding control unit 301 controls the image encoding unit 302 to insert an intra-coded picture as a reproduction start point.

In step S205, the image encoding unit 302 encodes the image according to the control. That is, the intra-coded picture is inserted as the reproduction start point to generate a bitstream. In step S206, the bitstream transmission unit 303 transmits the bitstream to the image reception device 103-1 and the image reception device 103-2. In step S214, the bitstream reception unit 401 of the image reception device 103-1 receives the bitstream transmitted from the image transmission device 102. Furthermore, in step S223, the bitstream reception unit 401 of the image reception device 103-2 receives the bitstream transmitted from the image transmission device 102.

In step S251 of FIG. 13, the image decoding unit 402 of the image reception device 103-1 decodes the received bitstream. Similarly, in step S261 of FIG. 13, the image decoding unit 402 of the image reception device 103-2 decodes the received bitstream.

For example, it is assumed that the image reception device 103-2 fails to receive the bitstream for some reason. In order to resume reception (reproduction), the bitstream reception unit 401 of the image reception device 103-2 requests the image transmission device 102 to generate a reproduction start point in step S262. The bitstream transmission unit 303 of the image transmission device 102 receives the request in step S241 of FIG. 13.

In step S242, the encoding control unit 301 of the image transmission device 102 sets a generation method for a reproduction start point according to whether or not the request source is the specific image reception device 103. A method of determining whether or not the request source is the specific image reception device 103 is any method, as described above. For example, an inquiry may be made to the management device 101, determination may be made on the basis of the most important reception device setting held by the encoding control unit 301, or determination may be made on the basis of information supplied from the request source. Since the image reception device 103-2 as the request source is the image reception device 103 (non-most important reception device) other than the specific image reception device 103, the encoding control unit 301 controls the image encoding unit 302 to insert intra refresh for a predetermined period as a reproduction start point.

In step S243, the image encoding unit 302 encodes the image according to the control. That is, the intra refresh for the predetermined period is inserted as the reproduction start point to generate a bitstream. In step S244, the bitstream transmission unit 303 transmits the bitstream to the image reception device 103-1 and the image reception device 103-2. In step S252, the bitstream reception unit 401 of the image reception device 103-1 receives the bitstream transmitted from the image transmission device 102. In step S252, the image decoding unit 402 of the image reception device 103-1 decodes the received bitstream. Similarly, in step S263, the bitstream reception unit 401 of the image reception device 103-2 receives the bitstream transmitted from the image transmission device 102. In step S264, the image decoding unit 402 of the image reception device 103-2 decodes the received bitstream.

### <Flow of Image Encoding Processing>

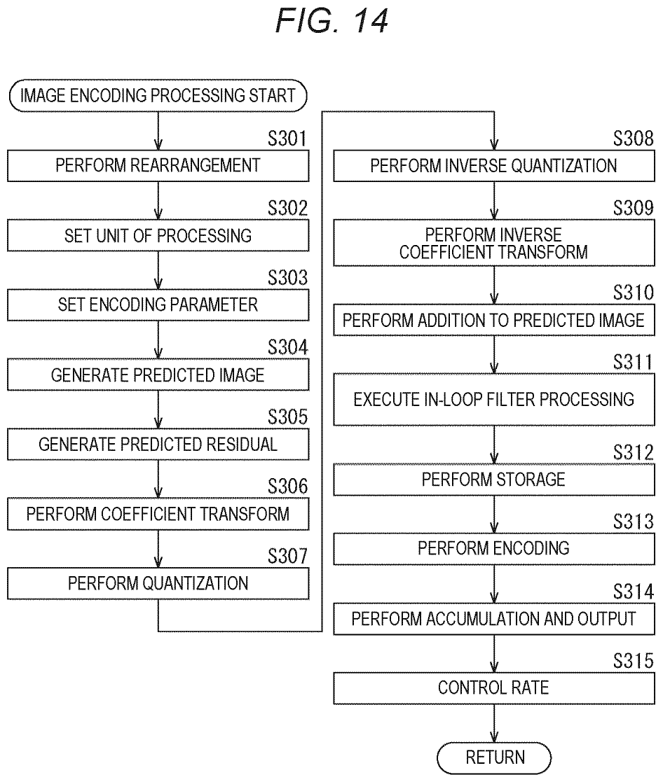

An example of a flow of image encoding processing executed in steps S201, S205, and S243 of such image transmission processing will be described with reference to a flowchart in FIG. 14.

When the image encoding processing is started, in step S301, the rearrangement buffer 351 is controlled by the control unit 350 to rearrange the order of frames of input moving image data from the display order to the encoding order.

In step S302, the control unit 350 sets a unit of processing of encoding, and divides the image held in the rearrangement buffer 351 into the units of processing.

In step S303, the control unit 350 sets encoding parameters.

In step S304, the prediction unit 362 performs prediction processing and generates a predicted image.

In step S305, the calculation unit 352 generates a predicted residual by using the image held in the rearrangement buffer 351 and the predicted image.

In step S306, the coefficient transform unit 353 performs coefficient transform on the predicted residual to generate a transform coefficient.

In step S307, the quantization unit 354 quantizes the transform coefficient and generates a quantization coefficient level.

In step S308, the inverse quantization unit 357 performs inverse quantization on the quantization coefficient level to generate a transform coefficient.

In step S309, the inverse coefficient transform unit 358 performs inverse coefficient transform on the transform coefficient to generate a predicted residual.

In step S310, the calculation unit 359 adds the predicted image to the predicted residual to generate a decoded image.

In step S311, the in-loop filter unit 360 executes the in-loop filter processing on the decoded image.

In step S312, the frame memory 361 stores the decoded image subjected to the in-loop filter processing or the decoded image not subjected to the in-loop filter processing.

In step S313, the encoding unit 355 encodes the quantization coefficient level and the like to generate coded data.

In step S314, the accumulation buffer 356 accumulates the coded data and supplies the coded data as a bitstream to the bitstream transmission unit 303 at any timing.

In step S315, the rate control unit 363 sets the quantum parameter (PictureQp), as necessary, and performs rate control.

When the processing of step S315 ends, the image encoding processing ends, and the processing returns to the image transmission processing.

### <Flow of Image Decoding Processing>

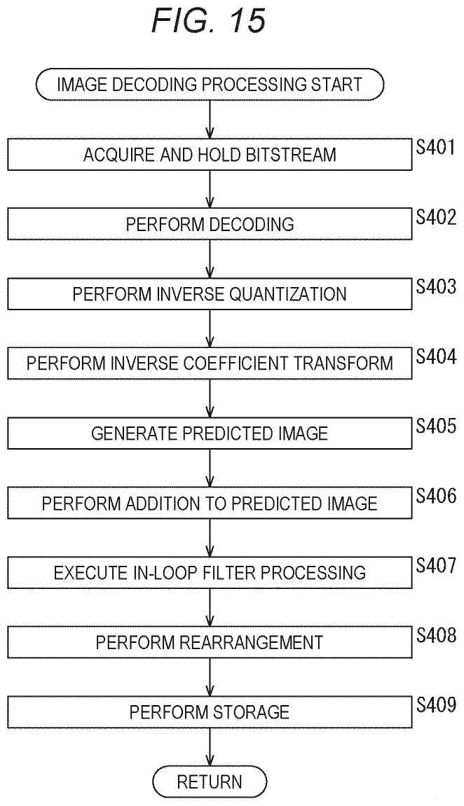

Furthermore, an example of a flow of image decoding processing executed in steps S212, S222, S251, S253, S261, and S264 of the image transmission processing will be described with reference to a flowchart in FIG. 15.

When the image decoding processing is started, in step S401, the accumulation buffer 451 acquires and holds (accumulates) the bitstream supplied from the bitstream reception unit 401.

In step S402, the decoding unit 452 decodes the bitstream to obtain a quantization coefficient level. Furthermore, the decoding unit 452 parses (analyzes and acquires) various encoding parameters from the bitstream by the decoding.

In step S403, the inverse quantization unit 453 performs inverse quantization on the quantization coefficient level obtained by the processing in step S402 to obtain a transform coefficient.

In step S404, the inverse coefficient transform unit 454 performs inverse coefficient transform processing on the transform coefficient obtained in step S403 to obtain a predicted residual.

In step S405, the prediction unit 459 executes prediction processing by a prediction method designated by the encoding side on the basis of information parsed in step S402, and generates a predicted image by referring to a reference image stored in the frame memory 458, or the like.

In step S406, the calculation unit 455 adds the predicted residual obtained in step S404 and the predicted image obtained in step S405 together to derive a locally decoded image.

In step S407, the in-loop filter unit 456 performs in-loop filter processing on the locally decoded image obtained by the processing in step S406.

In step S408, the rearrangement buffer 457 derives decoded images by using the locally decoded image subjected to the filtering processing obtained by the processing in step S407, and rearranges the order in a decoded image group thereof from the decoding order to the reproduction order. The decoded image group rearranged in the reproduction order is output as a moving image to the outside of the image decoding unit 402.

Furthermore, in step S409, the frame memory 458 stores at least one of the locally decoded image obtained by the processing in step S406 or the locally decoded image after the filter processing obtained by the processing in step S407.

When the processing of step S409 ends, the image decoding processing ends, and the processing returns to the image transmission processing.

### <Case Where Most Important Reception Device Starts Reproduction>

As described above, the generation method for a reproduction start point is switched according to the image reception device 103 that starts reproduction. For example, a case will be described where the specific image reception device 103 (that is, the most important reception device) starts reproduction.

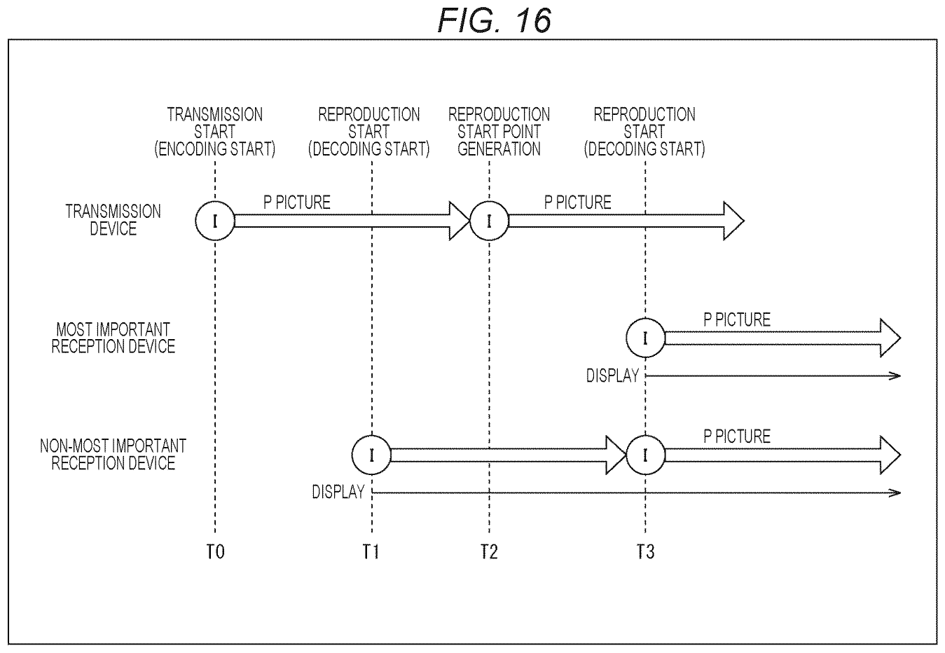

In this case, as illustrated in FIG. 16, an I picture is inserted as a reproduction start point. For that reason, reproduction (decoding) of an image by the most important reception device can be started as soon as the I picture is received. That is, the reproduction (decoding) of the image by the most important reception device can be started with less delay. However, in the image reception device 103 (that is, the non-most important reception device) other than the specific image reception device 103, the I picture is inserted during reproduction.

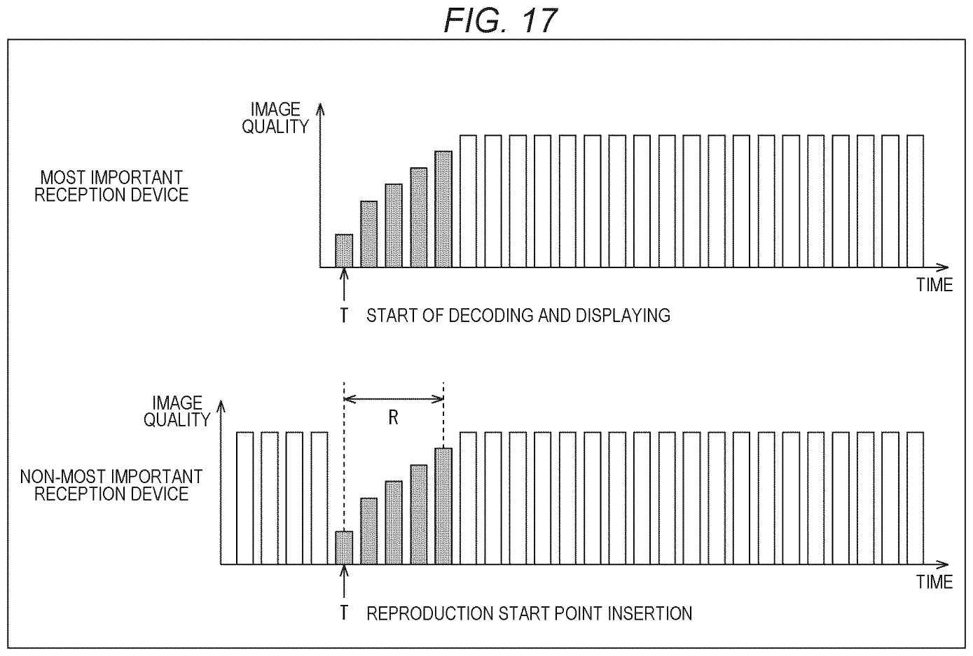

FIG. 17 illustrates an example of a change in the image quality of each reproduced image in this case. Since the I picture is inserted, the image quality of the reproduced image is greatly degraded in both the most important reception device and the non-most important reception device. However, in the reproduction by the most important reception device, the image quality is degraded only for a short period of time at the reproduction start with relatively low degree of importance, and thus, the substantial influence is small. On the other hand, in the reproduction by the non-most important reception device, the image quality is degraded in the middle of the reproduction. However, the degree of importance of the reproduced image by the non-most important reception device is lower than that of the reproduced image by the most important reception device. In addition, since a period R thereof is also a short period as in the case of the most important reception device, there is little substantial influence.

### <Case Where Non-Most Important Reception Device Starts Reproduction>

Next, a case will be described where the image reception device 103 (that is, the non-most important reception device) other than the specific image reception device 103 starts reproduction.

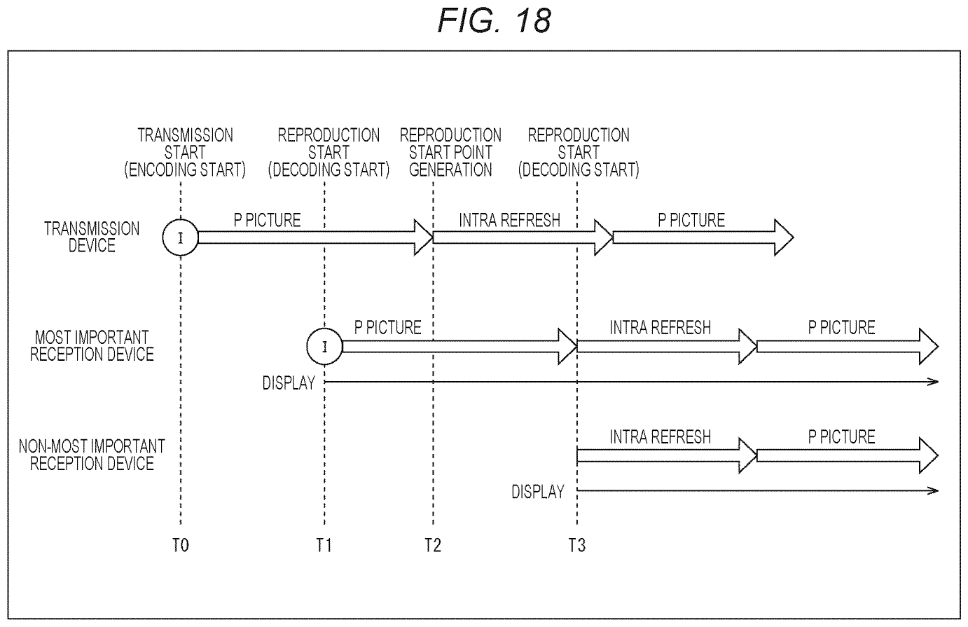

In this case, as illustrated in FIG. 18, intra refresh for a predetermined period is inserted as a reproduction start point. For that reason, a reproduced image of the non-most important reception device is displayed after the end of the predetermined period. Furthermore, in reproduction (decoding) of an image by the most important reception device, intra refresh is inserted in the middle of reproduction.

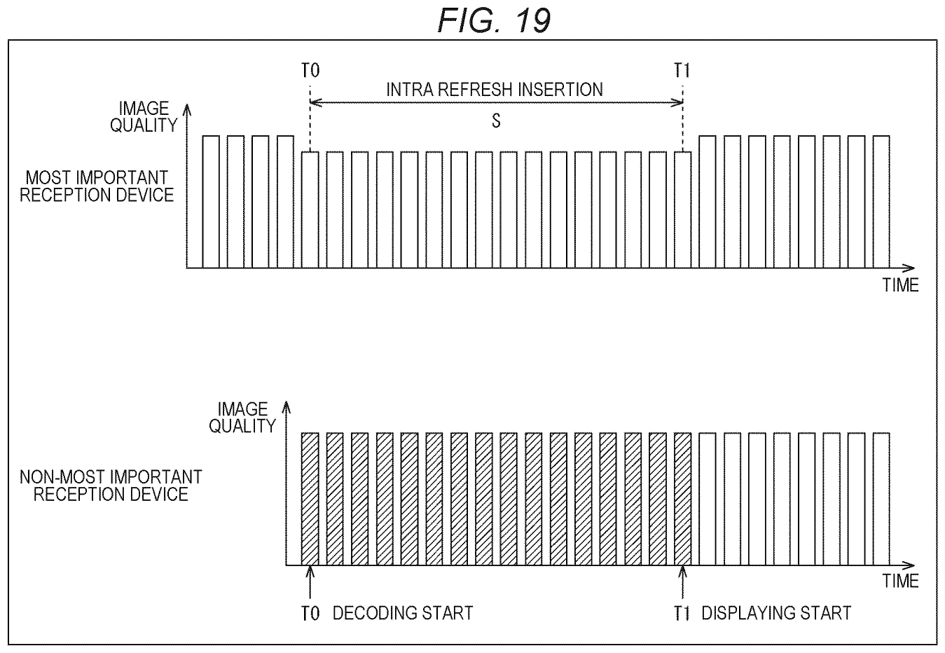

FIG. 19 illustrates an example of a change in the image quality of each reproduced image in this case. As illustrated in FIG. 19, in the case of the insertion of the intra refresh, the image quality is less reduced than that in the case of the insertion of the I picture. Thus, it is possible to suppress degradation in the image quality of the reproduced image of the most important reception device. Furthermore, the display start timing of the non-most important reception device is later than that in the case where the I picture is inserted, but the degree of importance of the reproduced image of the non-most important reception device is lower than that of the reproduced image of the most important reception device, so that the substantial influence is small.

As described above, the generation method for a reproduction start point is switched according to the image reception device 103 that starts reproduction, so that it is possible to suppress image quality degradation due to the reproduction start.

### 4. Application Examples

Note that the number of specific image reception devices 103 is any number, and may be, for example, a plural number. Furthermore, a generation method for a reproduction start point is any method, and is not limited to the insertion of the I picture and the insertion of the intra refresh described above. Furthermore, the number of candidates for the generation method is any number. For example, the generation method may be selected from three or more types of methods. Furthermore, the generation method may be switched in multiple stages. For example, the image reception devices 103 may be classified into three or more stages such as most important, important, and unimportant, and the generation method may be switched in each stage. Furthermore, for example, the next most important reception device may be set in addition to the current most important reception device.

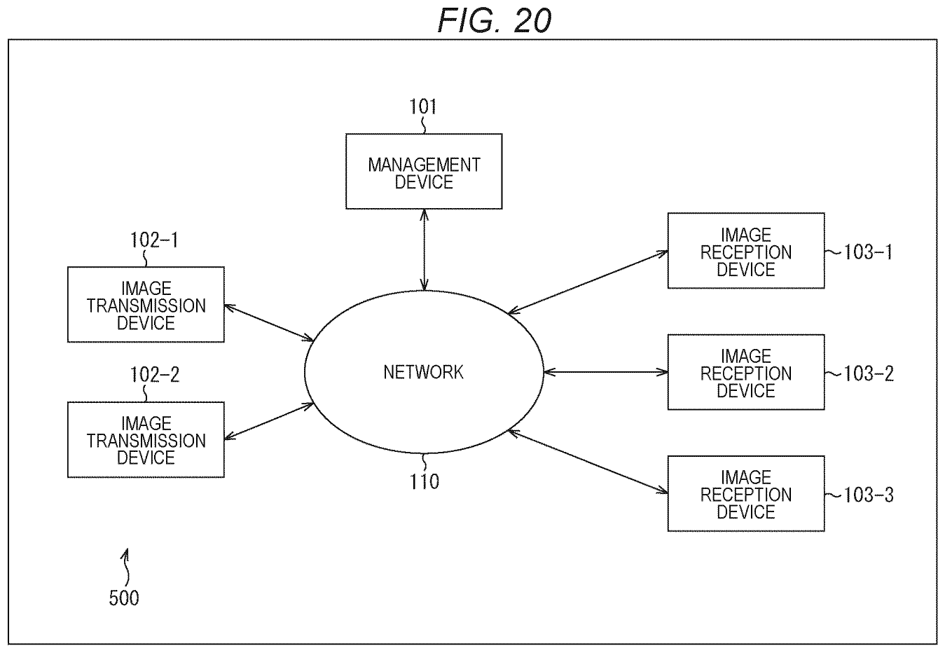

Note that the start of reproduction described above may also include switching of the image transmission device 102 that receives the bitstream. For example, as in an image transmission system 500 illustrated in FIG. 20, there may be a plurality of image transmission devices 102. For example, the image reception device 103-1 that has received a bitstream transmitted from the image transmission device 102-1 may receive a bitstream transmitted from an image transmission device 102-2 at a certain timing. In that case, the most important reception device for the image transmission device 102-1 or the most important reception device for the image transmission device 102-2 may change. Furthermore, the most important reception device for the image transmission device 102-1 and the most important reception device for the image transmission device 102-2 may be different from each other. That is, the most important reception device for the image transmission device 102-1 may be the image reception device 103-1, and the most important reception device for the image transmission device 102-2 may be the image reception device 103-2. Also in that case, it is only required to perform the setting processing as described above to perform the most important reception device setting.

Although the image transmission system used for video production has been described above, the present technology can be applied to an image transmission system for any application. For example, the image transmission system 100 and the image transmission system 500 may be a video conference system or a monitoring system.

### 5. Supplementary Note

### <Computer>

The above-described series of processing can be executed by hardware or software. In a case where the series of processing is executed by the software, a program that configures the software is installed in a computer. Here, the computer includes a computer incorporated in dedicated hardware, a general-purpose personal computer capable of executing various functions by installing various programs, and the like, for example.

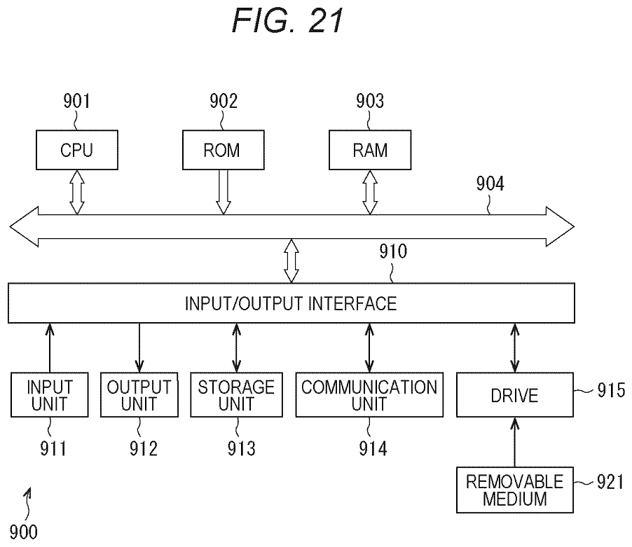

FIG. 21 is a block diagram illustrating a configuration example of hardware of a computer that executes the above-described series of processing by a program.

In a computer 900 illustrated in FIG. 21, a central processing unit (CPU) 901, a read only memory (ROM) 902, and a random access memory (RAM) 903 are connected to each other via a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. Furthermore, the RAM 903 also appropriately stores data and the like necessary for the CPU 901 to execute various types of processing.

A program executed by the computer can be applied by being recorded on the removable medium 921 as a package medium or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, the program can be installed in the ROM 902 or the storage unit 913 in advance.

### <Configuration to Which Present Technology is Applicable>

The present technology may be applied to any configuration. For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or a device (for example, a hard disk recorder and a camera) that records an image on a medium such as an optical disk, a magnetic disk, and a flash memory, or reproduces an image from the storage medium.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Thus, a plurality of devices housed in different housings and connected together via a network and one device in which a plurality of modules is stored in one housing are both systems.

### <Field and Application to Which Present Technology is Applicable>

The system, device, processing unit, and the like to which the present technology is applied can be used in any field such as traffic, medical care, crime prevention, agriculture, livestock industry, mining, beauty care, factory, household appliance, weather, and natural surveillance, for example. Furthermore, any application thereof may be used.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices used for use in agriculture and livestock industry. Furthermore, the present technology can also be applied to systems and devices that monitor, for example, the status of nature such as a volcano, a forest, and the ocean, wildlife, and the like. Moreover, for example, the present technology can also be applied to systems and devices used for sports.

### <Others>

An embodiment of the present technology is not limited to the embodiment described above, and various modifications can be made without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, if the configuration and operation of the entire system are substantially the same, a part of the configuration of a certain device (or processing unit) may be included in the configuration of another device (or another processing unit).

Furthermore, for example, the above-described programs may be executed in any device. In this case, the device is only required to have a necessary function (functional block or the like) and obtain necessary information.

Furthermore, for example, each step of one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, the plurality of pieces of processing included in one step can also be executed as pieces of processing of a plurality of steps. Conversely, processing described as a plurality of steps can also be collectively executed as one step.

Furthermore, for example, in a program executed by the computer, processing of steps describing the program may be executed in a time-series order in the order described in the present specification, or may be executed in parallel or individually at a required timing such as when a call is made. That is, the pieces of processing of the respective steps may be executed in an order different from the above-described order as long as there is no contradiction. Moreover, this processing in steps describing program may be executed in parallel with processing of another program, or may be executed in combination with processing of another program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that, the present technology can also have the following configurations.
(1) A transmission device including:
   an encoding unit that encodes an image and generates a bitstream;
   a transmission unit that transmits the bitstream to a plurality of reception devices; and
   an encoding control unit that sets a generation method for a reproduction start point according to one of the reception devices that starts reproduction, and controls the encoding unit to generate the reproduction start point by the generation method set. (2) The transmission device according to (1), in which
   the encoding control unit causes intra refresh for a predetermined period to be applied as the reproduction start point for a reception device other than a specific reception device among the plurality of reception devices.
(3) The transmission device according to (1) or (2), in which
   the encoding control unit causes an intra-coded picture to be applied as the reproduction start point for a specific reception device among the plurality of reception devices.
(4) The transmission device according to any of (1) to (3), in which
   the encoding control unit holds specific reception device information indicating a specific reception device, performs determination as to whether the one of the reception devices that starts reproduction matches the specific reception device information, and sets the generation method on the basis of a result of the determination.
(5) The transmission device according to any of (1) to (3), in which
   the encoding control unit sets the generation method on the basis of information indicating whether or not the one of the reception devices that starts reproduction is a specific reception device, the information being provided from a management device.
(6) The transmission device according to any of (1) to (3), in which
   the encoding control unit sets the generation method on the basis of information indicating whether or not the one of the reception devices that starts reproduction is a specific reception device, the information being provided from the one of the reception devices that starts reproduction.
(7) The transmission device according to any of (1) to (6), in which
   the encoding control unit causes an intra-coded picture to be applied as the reproduction start point for a reception device to which a moving image used for broadcasting is transmitted among the plurality of reception devices, and causes intra refresh for a predetermined period to be applied as the reproduction start point for another reception device to which a moving image used for other than broadcasting is transmitted.
(8) A transmission method including:
   encoding an image and generating a bitstream;
   transmitting the bitstream to a plurality of reception devices; and
   setting a generation method for a reproduction start point according to one of the reception devices that starts reproduction, and generating the reproduction start point by the generation method set.
(9) A program for causing a computer to function as:
   an encoding unit that encodes an image and generates a bitstream;
   a transmission unit that transmits the bitstream to a plurality of reception devices; and
   an encoding control unit that sets a generation method for a reproduction start point according to one of the reception devices that starts reproduction, and controls the encoding unit to generate the reproduction start point by the generation method set.
(10) A management device including
   a setting unit that sets a specific reception device among a plurality of reception devices capable of receiving bitstreams identical to each other transmitted from a transmission device.
(11) The management device according to (10), in which
   the setting unit
      holds specific reception device information indicating the specific reception device set, and
      performs determination as to whether or not a reception device retrieved from the transmission device is the specific reception device on the basis of the specific reception device information, and
   a transmission unit that transmits a result of the determination to the transmission device is further included.
(12) The management device according to (10), in which
   the setting unit
      causes the transmission device to hold specific reception device information indicating the specific reception device set.
(13) The management device according to (10), in which
   the setting unit
      causes the reception devices to hold specific reception device information indicating the specific reception device set.
(14) The management device according to any of (10) to (13), further including
   a monitoring unit that monitors a network, in which
   the setting unit sets the specific reception device in a case where the monitoring unit detects update of the reception devices capable of receiving the bitstreams.
(15) A management method including:
   setting a specific reception device among a plurality of reception devices capable of receiving bitstreams identical to each other transmitted from a transmission device.
(16) A program for causing a computer to function as
   a setting unit that sets a specific reception device among a plurality of reception devices capable of receiving bitstreams identical to each other transmitted from a transmission device.
(17) A reception device including:
   a reception unit that holds information indicating whether or not the reception device is a specific reception device, provides a transmission device with the information and requests the transmission device to generate a reproduction start point when reproduction is started, and receives a bitstream transmitted from the transmission device; and
   a decoding unit that decodes the bitstream and generates an image.
(18) The reception device according to (17), in which
   the reception unit receives and holds the information transmitted from a management device.
(19) A receiving method including:
   holding information indicating whether or not the reception device is a specific reception device, providing a transmission device with the information and requesting the transmission device to generate a reproduction start point when reproduction is started, and receiving a bitstream transmitted from the transmission device; and
   decoding the bitstream and generating an image.
(20) An image transmission system including:
   a transmission device that transmits bitstreams including coded data of an image; and
   a plurality of reception devices capable of receiving the bitstreams identical to each other transmitted from the transmission device, in which
   the transmission device includes:
      an encoding unit that encodes the image and generates the bitstreams;
      a transmission unit that transmits the bitstreams to the plurality of reception devices; and
      an encoding control unit that sets a generation method for a reproduction start point according to one of the reception devices that starts reproduction, and controls the encoding unit to generate the reproduction start point by the generation method set, and
   the reception devices each include:
      a reception unit that requests the transmission device to generate the reproduction start point when reproduction is started, and receives a bitstream transmitted from the transmission device; and
      a decoding unit that decodes the bitstream and generates an image.

### REFERENCE SIGNS LIST

100 Image transmission system
101 Management device
102 Image transmission device
103 Image reception device
110 Network
201 Configuration setting unit
202 Operation monitoring unit
203 Communication unit
301 Encoding control unit
302 Image encoding unit
303 Bitstream transmission unit
401 Bitstream reception unit
402 Image decoding unit
500 Image transmission system
900 Computer

1. A transmission device comprising:
an encoding unit that encodes an image and generates a bitstream;
a transmission unit that transmits the bitstream to a plurality of reception devices; and
an encoding control unit that sets a generation method for a reproduction start point according to one of the reception devices that starts reproduction, and controls the encoding unit to generate the reproduction start point by the generation method set.

2. The transmission device according to claim 1, wherein
the encoding control unit causes intra refresh for a predetermined period to be applied as the reproduction start point for a reception device other than a specific reception device among the plurality of reception devices.

3. The transmission device according to claim 1, wherein
the encoding control unit causes an intra-coded picture to be applied as the reproduction start point for a specific reception device among the plurality of reception devices.

4. The transmission device according to claim 1, wherein
the encoding control unit holds specific reception device information indicating a specific reception device, performs determination as to whether the one of the reception devices that starts reproduction matches the specific reception device information, and sets the generation method on a basis of a result of the determination.

5. The transmission device according to claim 1, wherein
the encoding control unit sets the generation method on a basis of information indicating whether or not the one of the reception devices that starts reproduction is a specific reception device, the information being provided from a management device.

6. The transmission device according to claim 1, wherein
the encoding control unit sets the generation method on a basis of information indicating whether or not the one of the reception devices that starts reproduction is a specific reception device, the information being provided from the one of the reception devices that starts reproduction.

7. The transmission device according to claim 1, wherein
the encoding control unit causes an intra-coded picture to be applied as the reproduction start point for a reception device to which a moving image used for broadcasting is transmitted among the plurality of reception devices, and causes intra refresh for a predetermined period to be applied as the reproduction start point for another reception device to which a moving image used for other than broadcasting is transmitted.

8. A transmission method comprising:
encoding an image and generating a bitstream;
transmitting the bitstream to a plurality of reception devices; and
setting a generation method for a reproduction start point according to one of the reception devices that starts reproduction, and generating the reproduction start point by the generation method set.

9. A program for causing a computer to function as:
an encoding unit that encodes an image and generates a bitstream;
a transmission unit that transmits the bitstream to a plurality of reception devices; and
an encoding control unit that sets a generation method for a reproduction start point according to one of the reception devices that starts reproduction, and controls the encoding unit to generate the reproduction start point by the generation method set.

10. A management device comprising
a setting unit that sets a specific reception device among a plurality of reception devices capable of receiving bitstreams identical to each other transmitted from a transmission device.

11. The management device according to claim 10, wherein
the setting unit
holds specific reception device information indicating the specific reception device set, and
performs determination as to whether or not a reception device retrieved from the transmission device is the specific reception device on a basis of the specific reception device information, and
a transmission unit that transmits a result of the determination to the transmission device is further included.

12. The management device according to claim 10, wherein
the setting unit
causes the transmission device to hold specific reception device information indicating the specific reception device set.

13. The management device according to claim 10, wherein
the setting unit
causes the reception devices to hold specific reception device information indicating the specific reception device set.

14. The management device according to claim 10, further comprising
a monitoring unit that monitors a network, wherein
the setting unit sets the specific reception device in a case where the monitoring unit detects update of the reception devices capable of receiving the bitstreams.

15. A management method comprising:
setting a specific reception device among a plurality of reception devices capable of receiving bitstreams identical to each other transmitted from a transmission device.

16. A program for causing a computer to function as
a setting unit that sets a specific reception device among a plurality of reception devices capable of receiving bitstreams identical to each other transmitted from a transmission device.

17. A reception device comprising:
a reception unit that holds information indicating whether or not the reception device is a specific reception device, provides a transmission device with the information and requests the transmission device to generate a reproduction start point when reproduction is started, and receives a bitstream transmitted from the transmission device; and
a decoding unit that decodes the bitstream and generates an image.

18. The reception device according to claim 17, wherein
the reception unit receives and holds the information transmitted from a management device.

19. A reception method comprising:
holding information indicating whether or not the reception device is a specific reception device, providing a transmission device with the information and requesting the transmission device to generate a reproduction start point when reproduction is started, and receiving a bitstream transmitted from the transmission device; and
decoding the bitstream and generating an image.

20. An image transmission system comprising:
a transmission device that transmits bitstreams including coded data of an image; and
a plurality of reception devices capable of receiving the bitstreams identical to each other transmitted from the transmission device, wherein
the transmission device includes:
an encoding unit that encodes the image and generates the bitstreams;
a transmission unit that transmits the bitstreams to the plurality of reception devices; and
an encoding control unit that sets a generation method for a reproduction start point according to one of the reception devices that starts reproduction, and controls the encoding unit to generate the reproduction start point by the generation method set, and
the reception devices each include:
a reception unit that requests the transmission device to generate the reproduction start point when reproduction is started, and receives a bitstream transmitted from the transmission device; and
a decoding unit that decodes the bitstream and generates an image.
